(19) United States
(12) Patent Application Publication
(10) Pub. No.: US 2026/0100838 A1
(43) Pub. Date: Apr. 9, 2026

(54) ZERO-KNOWLEDGE PROOF

(71) Applicant: nChain Licensing AG, Zug (CH)

(72) Inventor: Enrique LARRAIA, London (GB)

(21) Appl. No.: 19/114,378

(22) PCT Filed: Aug. 16, 2023
(86) PCT No.: PCT/EP2023/072606

§ 371 Date: Mar. 21, 2025

(30) Foreign Application Priority Data
Sep. 23, 2022 (GB) 2213915.8

(51) Int. Cl. H04L 9/32; H04L 9/06

(52) U.S. Cl. CPC H04L 9/3218; H04L 9/0643; H04L 2209/30

(57) ABSTRACT

A computer-implemented method for generating a zero-knowledge proof for proving knowledge of a pre-image value. A series of pre-image blocks is obtained which, when combined, form the pre-image value. A series of nodes are executed, wherein each node of the series is configured to: receive a respective current state and a respective current iteration counter; evaluate an instance of a predefined compression function, based on the respective current state, to compute a respective next state; increment the respective current iteration counter to generate a respective next iteration counter; determine, based on a respective next pre-image block of the series of pre-image blocks, that the predefined compression function instance has been evaluated correctly; and output a proof, wherein the proof attests to the predefined compression function instance being evaluated correctly. The proof generated by a final node of the series of nodes proves knowledge of the pre-image value.

### CROSS REFERENCE TO RELATED APPLICATIONS

This application is the U.S. National Stage of International Application No. PCT/EP2023/072606 filed on Aug. 16, 2023, which claims the benefit of United Kingdom Patent Application No. 2213915.8, filed on Sep. 23, 2022, the contents of which are all incorporated herein by reference in their entireties.

### TECHNICAL FIELD

The present disclosure relates to a method for generating a zero-knowledge proof for proving knowledge of a pre-image value, and a computer system for implementing the method.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicized. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

### SUMMARY

Known succinct zero-knowledge arguments of knowledge (SNARKs) for knowledge of hash preimages, or for Merkle tree statements, for example, like proving knowledge of an authentication path consistent with a Merkle root, typically prove knowledge either of a witness taken from a fixed domain, or a witness of varying size but upper bounded by a small constant. This is due to the monolithic approach of expressing the entire computation as a single circuit and then proving satisfiability of this circuit in one computation. Indeed, the larger the size of the witness, the larger the size of the circuit, and the more time/space consuming the prover algorithm becomes.

New methods for generating zero-knowledge proof are provided herein, which depart from the known monolithic approach. Instead, recursive SNARKs, or more concretely, proof carrying data (PCD) are used. PCD is a primitive to prove correct evaluation of distributed computations (whose transcript can be described with a graph). Each node attaches an easy-to-verify proof to its output attesting to (i) the compliance of its input, output, and local data with a given predicate Π(zᵢₙ,z_{loc},zₒᵤₜ)=1 and (ii) the validity of the proofs attached to the input data. Due to the recursive nature of the proof generation (that verifies incoming proofs), the verifier only needs to verify the proof produced by the last (sink) nodes of the computation transcript.

The focus is twofold:
a) Interpret the entire computation as a ‘distributed’ computation. Thus, the, potentially large, computation is split into a series of small subroutines (yielding manageable circuits). Each node executes a given subroutine instantiation only—especially, if a subroutine is one step of a loop, there will be as many nodes as loop iterations—.
b) Leveraging an existing PCD scheme for the spelled-out compliant computation transcript build the resulting SNARK (which internally calls the PCD algorithms).

Any PCD scheme can be used for step (b). In section 8.1, the choice of the curve when working with pairing-based preprocessing PCDs is discussed.

According to one aspect disclosed herein, there is provided a computer-implemented method for generating a zero-knowledge proof for proving knowledge of a pre-image value, the method comprising: obtaining a series of pre-image blocks which, when combined, form the pre-image value; and executing a series of nodes, wherein each node of the series of nodes is configured to: receive a respective current state and a respective current iteration counter; evaluate an instance of a predefined compression function, based on the respective current state, to compute a respective next state; increment the respective current iteration counter to generate a respective next iteration counter; determine, based on a respective next pre-image block of the series of pre-image blocks, that the predefined compression function instance has been evaluated correctly; and output a proof, wherein the proof attests to the predefined compression function instance being evaluated correctly; wherein the proof generated by a final node of the series of nodes proves knowledge of the pre-image value.

The present disclosure provides succinct zero-knowledge arguments of knowledge (SNARKs) for hash-based statements. The proof generation is scalable and incrementally computable. For example, to prove knowledge of arbitrarily large SHA256 preimages (e.g., preimages of 1 GB or even more) the memory requirement for the prover can be the same as the requirement to prove knowledge of preimages of 512 bits. The proof system provided herein may be used to prove knowledge of a preimage is of arbitrary size. That is, the same may be used as the proof system for any preimage size.

In general, the running time of the prover scales well on the size of the private input (the witness—which e.g., can be a large preimage or many leaves of a Merkle tree). This means that there are no strong requirements on the hardware (RAM) of the prover.

Also, the proof generation can be paused and resumed at a later stage, not necessarily by the same prover. In particular, the proof generation can be distributed across a number of nodes that only know a portion of the private input. This can be achieved due to the incremental nature of the SNARKs provided herein.

The succinct property of the SNARK also guarantees the proof size is constant regardless of the size of witness (or just logarithmic in the size of the witness).

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 schematically illustrates a computation transcript for a function ƒ(x,y):=(2(x+y),3(x+y)) with bounded noise;

FIG. 4 schematically illustrates a SHA2 transcript;

FIG. 5 schematically illustrates the input relationships of SHA2 nodes;

FIG. 6 provides an example method for proving knowledge of a pre-image using a zero-knowledge proof;

FIG. 7 schematically illustrates a Merkle tree for generating a zero-knowledge proof for proving each leaf of the Merkle tree satisfies a criterion;

FIG. 8 provides an example method for proving each leaf of the Merkle tree satisfies the criterion;

FIG. 9 schematically illustrates a transcript for multi-predicate \vec{Π} for efficient and scalable zero-knowledge proofs; and

FIG. 10 shows an example method for purchasing data using scalable zero-knowledge proofs.

### DETAILED DESCRIPTION OF EMBODIMENTS

### 1. Example System Overview

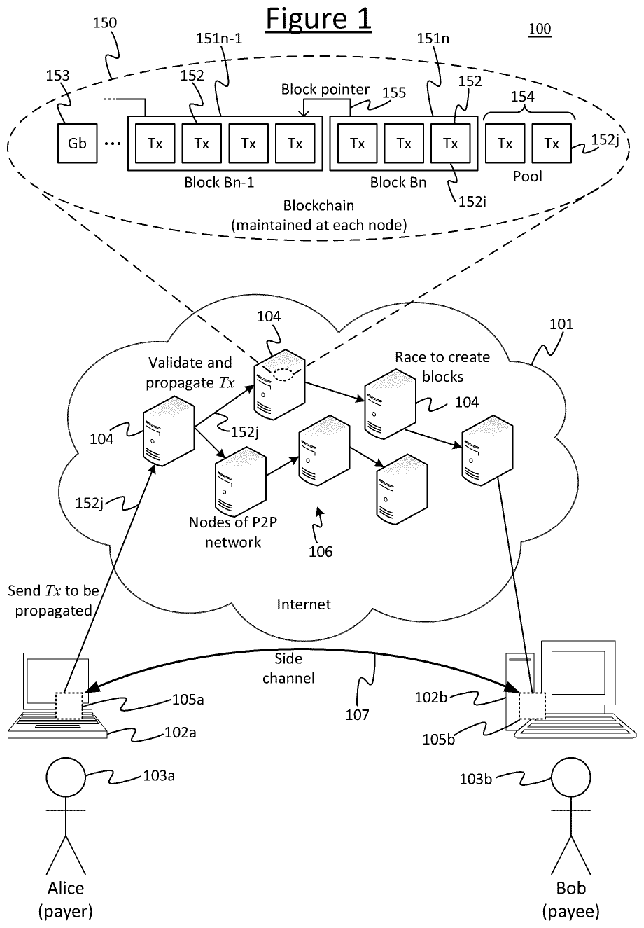

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”.

This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction spends (or “assigns”), wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (or “spent”) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore, this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it spends or assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorize (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### 2. UTXO-Based Model

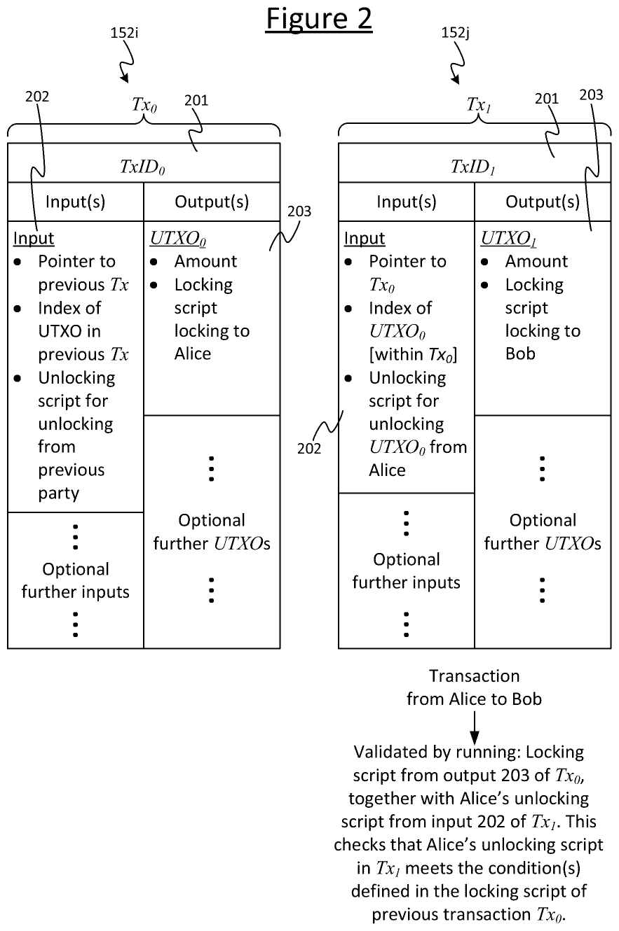

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx, if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:
<Sig P_{A}><P_{A}>||[Checksig P_{A}]
   where “| |” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx, contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned (or spent) by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150.

There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_. . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 3. Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### 4. SHA2 Hashes

SHA2 is a family of cryptographic hash algorithms that takes as input an [symbol] -bit message M∈{0,1 [symbol] and produces a d-bit digest H∈{0,1}^{d}. The length of M can vary up to a certain upper bound [symbol] < [symbol] . The length of the digest is fixed. “SHAd” is used to denote the cryptographic hash function of SHA2 family that outputs digests of size d.

SHAd proceeds in two steps. First, an [symbol] -bit message M is split into N blocks of fixed size m. For this, padding is needed, where:

$${M}^{( 1 )} \vert \vert … \vert \vert {M}^{( N - 1 )} \vert \vert {M}^{( N )} := pad ( M )$$

Padding is defined as follows: Let k be the smallest integer such that [symbol] +1+k≡(m− [symbol] ₘₐₓ) mod m. Append 1 to the end of M followed by k zeros. Then, append the [symbol] ₘₐₓ-bit block that corresponds to the binary expression of [symbol] . The result of padding adds at most one extra block. If the [symbol] bits of message M fit in B blocks of m bits each, after padding, there are at most B+1 blocks. The extra block is added only if [symbol] mod m≥m− [symbol] ₘₐₓ.

The second step of SHAd applies iteratively the compression function

$${CF}_{m , d} : {\{ 0 , 1 \}}^{m} \times {\{ 0 , 1 \}}^{d} ⟶ {\{ 0 , 1 \}}^{d}$$

on input the message block and the previous compressed value. The first compressed value is the initialization vector IV, and it is set to a concrete constant d-bit array for each SHAd function. In summary, SHAd(M) algorithm is:

$${M}^{( 1 )} \vert \vert … \vert \vert {M}^{( N - 1 )} \vert \vert {M}^{( N )} := pad ( M ) . \qquad 1$$

$$Set {H}^{( 0 )} := IV . \qquad 2$$

$$For i = 1 to N compute {H}_{i} := {CF}_{m , d} ( {H}^{( i - 1 )} , {M}^{( i )} ) . \qquad 3$$

$$Output H := {H}^{( N )} . \qquad 4$$

The following table provides the parameters for SHA256 and SHA512 functions.

| SHA2 | | | | |
|---|---|---|---|---|
| function | d | m | [symbol] ₘₐₓ | IV |
| SHA256 | 256 | 512 | 64 | 6a09e667bb67ae853c6ef372a54ff53a |
| | | | | 510e527f9b05688c1f83d9ab5be0cd19 |
| SHA512 | 512 | 1024 | 128 | 6a09e667f3bcc908bb67ae8584caa73b |
| | | | | 3c6ef372fe94f82ba54ff53a5f1d36f1 |
| | | | | 510e527fade682d19b05688c2b3e6c1f |
| | | | | 1f83d9abfb41bd6b5be0cd19137e2179 |

### 5. Proof Systems

5.1 zkSNARKs

Let an efficiently computable binary program P(x;w)=b∈{0,1} that takes, as a public input, a bitstring x (an instance) and, as private input, another bitstring w (a witness), and outputs a decision bit b. P accepts if b=1.

The associated NP relation [symbol] is given by the pairs of instance/witness that make the program P accept:

$$ℛ := \{ ( x , w ) \vert P ( x , w ) = 1 \} .$$

A pre-processing succinct non-interactive argument system of knowledge (SNARK) for correct execution of a program P is a triplet of algorithms SNARK:=(Gen,Prove,Verify) such that:
Gen(λ,P)→(pk,vk): On input a security parameter λ and the description of a program P it outputs a pair of proving and verification keys.
Prove (pk,x,w)→π: On input the proving key, the public input x and the private input w it outputs a proof π.
Verify (vk,x,π)→b∈{0,1}: On input the verification key, the public input x and the proof π it either accepts or rejects the proof.

Completeness, (knowledge) soundness and zero-knowledge. The SNARK is complete if the verifier always accepts proofs π generated by the prover SNARK. prove on input pairs (x, w) of public/private inputs that make the program P accept. It is sound if for all public inputs x for which there is no private input w that makes P accept, the verifier rejects any proof π for x with very high probability. If in addition it is possible to efficiently compute (extract) a witness from a valid proof π and the randomness that (a possibly cheating) prover used to generate π (up to some negligible error—the knowledge error), then the proof is said to be knowledge sound. The proof π is zero-knowledge if it reveals no information about w.

Succinctness. The proof is ‘short’. This means that it is logarithmic in the size of the private input w. More concretely, it has size poly(λ)polylog(|w|), where λ is a security parameter. The system has succinct verification (also referred as fully succinct) if, in addition to short proofs, the verifier runtime is ‘fast’. That is, it is logarithmic in both the size of the public input x and the size of the private input w. Thus, if the runtime takes poly(λ)polylog((|x|+[w]) steps, the system is fully succinct.

### 5.2 Proof Carrying Data

A proof carrying data (PCD) scheme provides means for proving integrity, or correctness, of dynamic computations distributed across nodes that do not trust each other. It differs from multiparty computation protocols in two main aspects: the number of nodes is not fixed, and privacy of the computation is not a concern. The latter allows PCDs to be more lightweight (no node communication overhead).

### 5.2.1 Multi-Predicate Transcripts

Transcripts J of dynamic computations are modelled as directed acyclic graphs G=(V,E) that originate from some source nodes, and end in output (sink) nodes. Edges (u,v)∈E are attached with data. Each node v∈V performs some computation involving incoming data

$${\vec{z}}_{in} := ( {z}_{in}^{( 1 )} , … , {z}_{in}^{( {s}_{v} )} ) ,$$

outgoing data zₒᵤₜ and (possibly) local data z_{loc}. The computation at node v must be compliant with some predicate Π. That is Π(\vec{z}ᵢₙ,\vec{z}_{loc},\vec{z}ₒᵤₜ)= “accept”.

Definition. A computation transcript is a tuple [symbol] :=(G,TYPE,LOC,PAYLOAD) such that:
G=(V,E) is a directed acyclic graph
TYPE: V→ [symbol] are node labels. (Compliance predicate the node adheres to.)
LOC:V→{0,1}* are another node labelling. (Local data.)
PAYLOAD: E→{0,1}* are edge labels. (Data flowing to and from nodes)

Messages and outputs. For edge (u,v)∈E, the message z attached to it has two parts: its type z.type:=(TYPE(u)) is the type of the parent node, and the payload z.payload:=PAYLOAD((u,v)) is the actual data. The outputs of the transcript out( [symbol] ), are the set of messages attached to edges (v,w) where w is an output (sink) node.

Transcript and output compliance. Let a vector of compliance predicates \vec{Π}=(Π₁, . . . Πₙ). A transcript [symbol] is \vec{Π}-compliant if it holds:
i. Let s∈V. We have TYPE(s)=0 if and only if s is a source node.
ii. For all non-source nodes v∈V, let i:=TYPE(v), let

$${z}_{in}^{( v )}$$

the incoming messages to v, let

$${z}_{out}^{( v )}$$

the outgoing message, and let

$${z}_{loc}^{( v )}$$

the local data. Then

$${Π}_{i} ( {\vec{z}}_{in}^{( v )} , {z}_{loc}^{( v )} , {z}_{out}^{( v )} ) = “ accept ” .$$

(Thus, a node must be compliant with the predicate given by its type.)

A message z is \vec{Π}-compliant if there exists a \vec{Π}-compliant transcript [symbol] such that z┌out( [symbol] ).

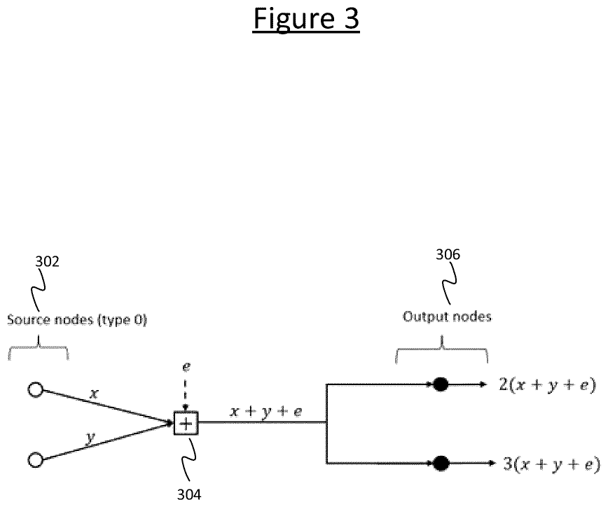

FIG. 3 is a schematic representation of a computation transcript for function ƒ(x,y):=(2(x+y),3(x+y)) with bounded noise. The computation transcript comprises two sources nodes 302, two output nodes 306, and an intermediate node 304. All non-source nodes 304, 306 enforce different compliance predicates on their inputs and outputs. The ‘+’ node (intermediate node 304) is allowed to introduce a bounded noise summand ∥e∥₂<B as local data for its computation.

### 5.2.2 Preprocessing PCDs

Syntax. A pre-processing PCD scheme is a triplet of algorithms ( [symbol] ), where the generator [symbol] takes as input the compliance predicates \vec{Π} and outputs a pair of proving/verifying keys (pk_{pcd},vk_{pcd}). For each non-source node, the prover [symbol] takes as input its incoming data zᵢₙ and proofs \vec{π}ᵢₙ attesting to the compliance of the parents nodes (provided they are non-source nodes), local data z_{loc}, and outgoing data zₒᵤₜ and produces a proof πₒᵤₜ:= [symbol] (pk_{pcd},(vk,zₒᵤₜ),(z_{loc},\vec{z}ᵢₙ,\vec{π}ᵢₙ)). The verifier [symbol] takes as input the outgoing data and the proof and either accepts or rejects. Typically, PCDs are built from succinct zero-knowledge proof systems (SNARKs) that can be recursed. Existing schemes fitted for recursion are provided and compared in section 8.1.

Security (knowledge soundness). If a set of proofs \vec{π}ₒᵤₜ for outgoing data \vec{z}ₒᵤₜ is accepting, then it is guaranteed that there exists a computation transcript [symbol] (and it is efficiently computed using [symbol] ) whose output (sink) nodes have outgoing data \vec{z}ₒᵤₜ (i.e., \vec{z}ₒᵤₜ=out ( [symbol] )), and all nodes (all the way back to the source nodes) have incoming/local/outgoing data that is \vec{Π}-compliant. Thus, the set of output proofs \vec{π}ₒᵤₜ attest for the compliance of the entire computation transcript.

### 6. Scalable Snarks for Hash-Based Statements

### 6.1 Knowledge of Arbitrarily Large SHA2 Preimages

A SNARK is defined for the following NP relation:

$${ℛ}_{SHA 2 preim} := \{ ( ( H , ℓ ) , M ) ∈ {\{ 0 , 1 \}}^{d} \times ℕ \times {\{ 0 , 1 \}}^{ℓ} \vert H = SHA {2}_{d , m , {ℓ}_{max} , IV} ( M ) \} .$$

Thus, knowledge of an [symbol] -bit preimage M (a private input) for a given public digest H and length [symbol] is proven. This relation is parameterized with a digest size d, a block size m, a maximum message length [symbol] ₘₐₓ and an initialization vector IV implicitly used in the evaluation of the SHA2 function.

### 6.1.1 Computation Transcript

A SHA2 evaluation can be viewed as a transcript of a dynamic computation. The i-th node receives, as input, a current iteration counter i−1 and a current state H⁽ⁱ⁻¹⁾, and it outputs an update i, H⁽ⁱ⁾, also referred to as a next iteration counter and a next state, where the next state is computed using the i-th message block M⁽ⁱ⁾ as local data. The first node receives as input the initialization vector, and the last node uses the message length [symbol] to pad the last block M^{(N)} and outputs H^{(N)}.

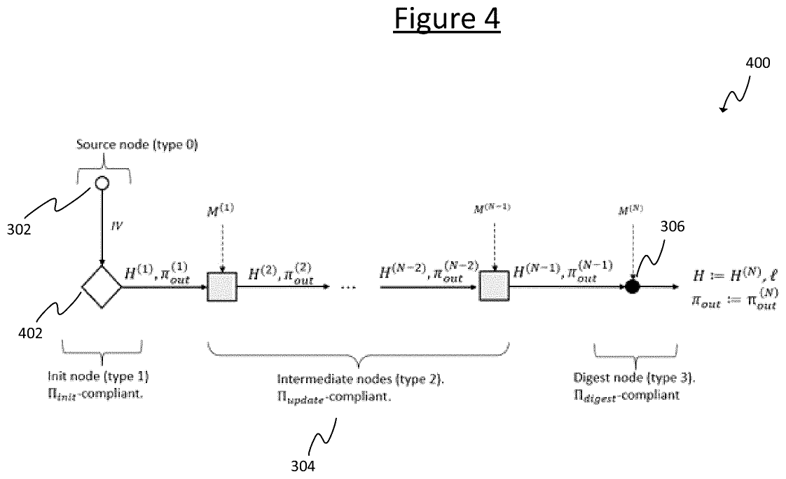

FIG. 4 shows schematically a SHA2 transcript 400 with a source node 302, an init node 402, intermediate nodes 304, and digest (output) nodes 306.

The message M is divided into a series of message blocks M⁽ⁱ⁾ such that:

$$M := ( {M}^{( 1 )} ‖ … ‖ {M}^{( N )} )$$

with a padding block M′^{(N)}, if required, defined by:

$${M}^{′ ( N )} := pad ( {M}^{( N )} )$$

The digest H is defined as:

$$H = SHAd ( M )$$

The message M may be referred to herein as a pre-image, and the message blocks M⁽ⁱ⁾ as pre-image blocks.

### 6.1.2 Node Compliance

The transcript 400 comprises a series of nodes: a source node 302 (type 0), init node 402 (type 1), intermediate state nodes 304 (type 2) and digest node 306 (type 3). The transcript 400 provides a method

For each non-source type node 402, 304, 306, a compression function criterion is enforced to attest that a predefined compression function has been correctly computed. Each of these nodes 402, 304, 306 take, as an input, a current state H⁽ⁱ⁻¹⁾ and apply the compression function to compute a next state H⁽ⁱ⁾ They also take as an input the current iteration counter i−1, which they increment to compute a next iteration counter i.

Each of these nodes 402, 304, 306 also executes a compression function evaluation check, to check that the compression function has been evaluated correctly. A next message block M⁽ⁱ⁾ is used in this check. The nodes 402, 304, 306 generate a proof attesting to the correct evaluation of the compression function at the node 402, 304, 306.

In this way, each of the nodes 402, 304, 306 executes a single iteration of the compression function. This allows the proof to be generated iteratively, both reducing the computation requirements of a prover, so improving the efficiency of the process, and allowing for proofs of arbitrarily large messages to be generated. The output of the final node 306 is the digest H and a preimage proof πₚᵣₑᵢₘ proving, in addition to the correct execution by the final node 306, that all previous nodes 402, 304 have correctly executed the compression function, and therefore proving knowledge of the message M.

In addition to checking the compression function, the first (init) node 402 and the final (digest) node 306 perform additional checks.

The first node 402 executes an initialisation check to check that a received initialization vector IV, received as part of its input, is correct. The received initialisation vector may be referred to as the current state for the first node 402, that is, H⁽⁰⁾=IV. The received initialization vector IV is compared to a predefined initialisation vector, and, if found to be equal, the received initialisation vector is determined to be correct. The predefined initialisation vector may be hardcoded into the first node 302. The first node 302 may also check that the current iteration counter received at the first node 302 has a first iteration count value, that is that iᵢₙ=0. In some embodiments, the first iteration count value may be 1.

The last node 306 executes a padding check. If the preimage fits in N m-bit blocks, then the last node 306 pads the last block M^{(N)} consistently with [symbol] -thus the padding length k+1 is such that:

$$ℓ + k + 1 = m - {ℓ}_{max} + ( N - b ) \cdot m$$

where m is the block length and N−1 is the input iteration counter for the final node 306. Here, b is either zero or one. If b=1 then no extra block when padding was used, that is the message M has a bit length [symbol] equal to the maximum bit length [symbol] ₘₐₓ. If the equation above is satisfied, it may be said that a padding condition is satisfied.

To execute the padding check, the final node 306 may receive, as an input, [symbol] , b and/or k, and check that the received values satisfy the equation:

$$ℓ + k + 1 = m - {ℓ}_{max} + ( N - b ) \cdot m$$

An extra padding block is needed if the required padding does not fit in the final message block. This is the case if the message length [symbol] is a multiple of the message length [symbol] ₘₐₓ, or if the padding bits of the message length do not fit in the last massage block.

If an extra padding block is needed, the final node 306 also receives the padding block, also referred to as a padding pre-image portion. The padding block has a length such that, when concatenated with the message, the total length is equal to the maximum bit length. The final node 306 executes the compression function again, this time taking the state and iteration counter already computed by the final node 306 as inputs. The compression function check uses the padding block to check that the compression function has been correctly evaluated. The proof generated by the final block 306 attests to both instances of the compression function being correctly evaluated.

If, instead, the no extra padding block is needed, the final node 306 outputs the state and proof generated with respect to the last message block of the message. That is, the final node 306 need not execute the compression function a second time.

The final node 306 checks that a final Imax bits of M are the binary expression of l. The definition of M is dependent on whether or not a padding portion has been added, as set out below. That is, if a final block is not added the slice of bits that are checked are in M⁽ⁱ^{ₒᵤₜ}⁾, whereas if a final block is added, the checked bits are somewhere in M⁽ⁱ^{ₒᵤₜ}⁾∥M′.

That is, the correct value of k must be provided as an input to the final node 306, whereas the value of M′ may be set to any value if no padding portion is added. This is because M′ is used neither in padding enforcement not in a second compression function evaluation in the case of no padding.

It is noted that SHA2 always adds some extra bits at the end of the message (referred to as padding). The difference is on which block the padding check is enforced. If M⁽ⁱ^{ₒᵤₜ}⁾ is the last block containing bits of the message, then either (i) padding fits in the block M⁽ⁱ^{ₒᵤₜ}⁾ entirely, or (ii) the extra padding block M′ is needed. In case (i), padding is enforced in M⁽ⁱ^{ₒᵤₜ}⁾, whereas in case (ii), padding is enforced in M′.

More generally, the final node 306 receives the final message block and the message length, and generates a correct padding of the message based on the message length—step 2 of Φ_{pad} set out below. This might involve generating the extra padding block containing padding information. The final node 306 then applies the compression function to the last message block and, if there is an extra padding block, also to the padding block. The final node 306 generates a proof attesting to the correctness of the padding and the application of the compression function. The proof is based on a received extra input bit b which indicates whether the extra block containing purely padding information only has been produced and passed through the compression function.

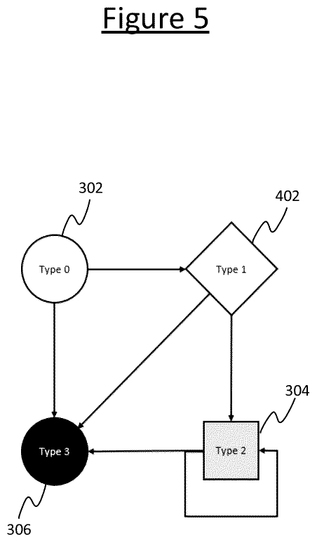

An intermediate state node 304 can only receive inputs from another intermediate state node 304 or from the first node 402. The digest node 306 can receive inputs from all types of nodes 302, 304, 402. These input relationships of SHA2 nodes are illustrated in FIG. 5.

The predicates are defined as \vec{Π}ₚᵣₑᵢₘ:=(Πᵢₙᵢₜ,Π_{update},Π_{digest}) capturing these enforcements. Internal gadgets Φ_{IV},Φₑᵥₐₗ,Φ_{pad} are set out below.

### Compliance of Init Node 402 (Type 1).

Πᵢₙᵢₜ(zᵢₙ,z_{loc},zₒᵤₜ):
1. Parse zᵢₙ payload as counter and state (iᵢₙ,H⁽ⁱ^{ᵢₙ}⁾)∈ [symbol] ×{0,1}^{d}
2. Parse z_{loc} as message block M⁽ⁱ^{ₒᵤₜ}⁾={0,1}^{m}
3. Parse zₒᵤₜ.payload as counter and state (iₒᵤₜ,H⁽ⁱ^{ₒᵤₜ}⁾)∈ [symbol] ×{0,1}^{d}
4. Check zᵢₙ.type=0.
5. Check that Φ_{IV}(iᵢₙ,H⁽ⁱ^{ᵢₙ}⁾) accepts.//See FIG. 4.
6. Check Φₑᵥₐₗ((iᵢₙ,H⁽ⁱ^{ᵢₙ}⁾,M⁽ⁱ^{ₒᵤₜ}⁾,(iₒᵤₜ, H⁽ⁱ^{ₒᵤₜ}⁾)) accepts.
7. If the three checks accept, output “accept”. Else output “reject”.

### Compliance of Intermediate State Nodes 304 (Type 2).

Π_{update} (zᵢₙ,z_{loc},zₒᵤₜ):
1. Parse zᵢₙ.payload as counter and state (iᵢₙ,H⁽ⁱ^{ᵢₙ}⁾)∈ [symbol] ×{0,1}^{d}
2. Parse z_{loc} as message block M⁽ⁱ^{ₒᵤₜ}⁾={0,1}^{m}
3. Parse zₒᵤₜ.payload as counter and state (iₒᵤₜ,H⁽ⁱ^{ₒᵤₜ}⁾)∈ [symbol] ×{0,1}^{d}
4. Check zᵢₙ.type ∈{1,2}.
5. Check Φₑᵥₐₗ((iᵢₙ,H⁽ⁱ^{ᵢₙ}⁾),M⁽ⁱ^{ₒᵤₜ}⁾,(iₒᵤₜ,H⁽ⁱ^{ₒᵤₜ}⁾)) accepts.
6. If the two checks accept, output “accept”. Else output “reject”.

### Compliance of Digest Node 306 (Type 3).

Π_{digest}(zᵢₙ,z_{loc},zₒᵤₜ):
1. Parse zᵢₙ.payload as counter and state (iᵢₙ,H⁽ⁱ^{ᵢₙ}⁾)∈ [symbol] ×{0,1}^{d}.
2. Parse z_{loc} as message block, extra padded block (if any), extra hash state (only used if extra padded block), counter, padding length, and a bit indicating if an extra block was added (M⁽ⁱ^{ₒᵤₜ}⁾,M′,H′,iₒᵤₜ,k,b)∈{0,1}^{m}×{0,1}^{d}× [symbol] ²×{0,1}.
3. Parse zₒᵤₜ.payload, as last state H⁽ⁱ^{ₒᵤₜ}⁾∈{0,1}^{d} and message length [symbol] ∈ [symbol]
4. Check zᵢₙ.type∈{0,1,2}.
5. If Zᵢₙ.type=0 check that Φ_{IV}(iᵢₙ,Hⁱ^{ᵢₙ}) accepts.//See FIG. 4.
6. If b=1 check that: Φₑᵥₐₗ((iᵢₙ,H⁽ⁱ^{ᵢₙ}⁾),M⁽ⁱ^{ₒᵤₜ}⁾,(iₒᵤₜ,H⁽ⁱ^{ₒᵤₜ}⁾)) accepts.
7. Else, (b=0, thus an extra block is added), check that:

$${Φ}_{eval} ( ( {i}_{in} , {H}^{( {i}_{in} )} ) , {M}^{( {i}_{out} )} , ( {i}_{out} , {H}^{′} ) ) accepts . \qquad a$$

$${Φ}_{eval} ( ( {i}_{out} , {H}^{′} ) , {M}^{′} , ( {i}_{out} + 1 , {H}^{( {i}_{out} )} ) ) accepts . \qquad b$$

8. Check that Φ_{pad}(M⁽ⁱ^{ₒᵤₜ}⁾,iₒᵤₜ, [symbol] ,k,b) accepts.

If all checks accept, output “accept”. Else output “reject”.

The table below shows the gadgets used internally by \vec{Π}ₚᵣₑᵢₘ. The block length m, digest length d, maximum message length [symbol] ₘₐₓ and the initialization vector IV are hardcoded in the descriptions.

| | |
|---|---|
| Φ_{IV}(iᵢₙ, H⁽ⁱ^{ᵢₙ}⁾): | Φₑᵥₐₗ ((iᵢₙ, H⁽ⁱ^{ᵢₙ}⁾), M⁽ⁱ^{ₒᵤₜ}⁾, (iₒᵤₜ, H⁽ⁱ^{ₒᵤₜ}⁾)): |
| 1. Check that H⁽ⁱ^{ᵢₙ}⁾ = IV | 1. Check that H⁽ⁱ^{ₒᵤₜ}⁾ := |
| 2. Check that iᵢₙ = 0 | CF_{m, d} (M⁽ⁱ^{ₒᵤₜ}⁾, H⁽ⁱ^{ᵢₙ}⁾) |
| 3. If the two checks accept, output “accept”. | 2. Check that iₒᵤₜ = iᵢₙ + 1 |
| Else output “reject”. | 3. If the two checks accept, output “accept”. |
| | Else output “reject”. |

Φ_{pad} (M⁽ⁱ^{ₒᵤₜ}⁾, M′, iₒᵤₜ, [symbol] , k, b):
1. Check that [symbol] + 1 + k = m − [symbol] ₘₐₓ + (iₒᵤₜ − b) · m. // b = 1 means no extra block when
padding. Else (b = 0), an extra block M′⁽ⁱ^{ₒᵤₜ}⁾ was added.
2. If b = 1, set M = M⁽ⁱ^{ₒᵤₜ}⁾. Else (b = 0) set M = M′. Check that last [symbol] ₘₐₓ bits of M is the
binary expression of [symbol] .
3. Check that the slice of M⁽ⁱ^{ₒᵤₜ}⁾||M′ between bits m − [symbol] ₘₐₓ − k and m − [symbol] ₘₐₓ is filled with
zeros and preceded by 1.
4. If the three checks accept, output “accept”. Else output “reject”.

### 6.1.3 the Snark

Let ( [symbol] ₚᵣₑᵢₘ, [symbol] ₚᵣₑᵢₘ, [symbol] ₚᵣₑᵢₘ) be a PCD scheme to prove \vec{Π}ₚᵣₑᵢₘ-compliance of messages.

The proof system to prove knowledge of SHA2 preimages is the triplet of algorithms SNARKₚᵣₑᵢₘ:=(Genₚᵣₑᵢₘ,Proveₚᵣₑᵢₘ,Verifyₚᵣₑᵢₘ) defined next.

Genₚᵣₑᵢₘ(λ,CF_{SHA2})→(pk, vk). It takes as input a security parameter λ and the description CF_{SHA2} of the compression function of SHA2 and it outputs a proving key pk (which contains CF_{SHA2}) and a verification key vk (which contains a succinct summary of CF_{SHA2}).

Proveₚᵣₑᵢₘ(pk,(H,M))→π_{SHA2}. It takes as input the proving key pk, and a pair (H,M)∈ [symbol] _{SHA2} and outputs a succinct proof π_{SHA2}. Steps:
1. Split the [symbol] -bit message M into N blocks M⁽ⁱ⁾ of m bits each. Let k+1 the padding length of M^{(N)}.
2. Set H⁽⁰⁾:=IV
3. Set H⁽⁰⁾:=⊥//Empty proof
4. For i=1 to N do:
   a. Compute H⁽ⁱ⁾:=CF_{m,d}(H⁽ⁱ⁻¹⁾, M⁽ⁱ⁾)//Assume H^{(N)}=H.
   b. Set input, local and output data:
      i. Set zᵢₙ.payload:=(i−1, H⁽ⁱ⁻¹⁾)
      ii. If i<N, set z_{loc}:=M⁽ⁱ⁾ and zₒᵤₜ.payload=(i,H⁽ⁱ⁾)//Type 1 or type 2 nodes (non-digest)
      iii. Else if i=N set z_{loc}:=(M⁽ⁱ⁾,M′,H,i,k,b) and zₒᵤₜ.payload=(H⁽ⁱ⁾, [symbol] )
   c. Set node type:
      i. If i=1& N≥2 set zᵢₙ.type=0 and zₒᵤₜ.type=1//Init node
      ii. If i=2 & N≥3 set zᵢₙ.type=1 and zₒᵤₜ.type=2://First intermediate state node
      iii. If N>i>2 & N≥3 set zᵢₙ.type=2 and zₒᵤₜ.type=2://Remaining intermediate state nodes
      iv. If i=N & N≥3 set zᵢₙ.type=2 and zₒᵤₜ.type=3//Digest node (with inputs from intermediate state node)
      v. If i=2 & N=2 set zᵢₙ.type=1 and zₒᵤₜ.type=3://Digest node (with inputs from source node)
      vi. If i=1 & N=1 set zᵢₙ.type=0 and zₒᵤₜ.type=3//Digest node (with inputs from source node)
      vii. Interpret pk as pk_{SHA2PCD} and compute

$${π}^{( i )} := {ℙ}_{preim} ( {pk}_{SHA 2 PCD} , {z}_{out} , ( {z}_{in} , {z}_{loc} , {π}^{( i - 1 )} ) ) .$$

5. Output π_{SHA2}:=π^{(N)}

It is more efficient for the prover to keep in memory data corresponding to the current iteration and delete data of old iterations. This way the output proof π_{SHA2} is computed incrementally.

Verifyₚᵣₑᵢₘ(H,π_{SHA2},vk)→{“accept”,“reject”}. It takes as input a verification key vk, a digest H and a proof π_{SHA2}, and it either accepts the proof or rejects it. Acceptance signals that H was correctly computed using SHA2 from a preimage M (not available to the verifier). Steps:
1. Parse vk as vk_{SHA2PCD}
2. Set zₒᵤₜ.type:=2 (digest node) and zₒᵤₜ.payload:=H
3. Run [symbol] ₚᵣₑᵢₘ(vk_{SHA2PCD},zₒᵤₜ,π_{SHA2}). If it accepts, output “accept”. Else output “reject”.

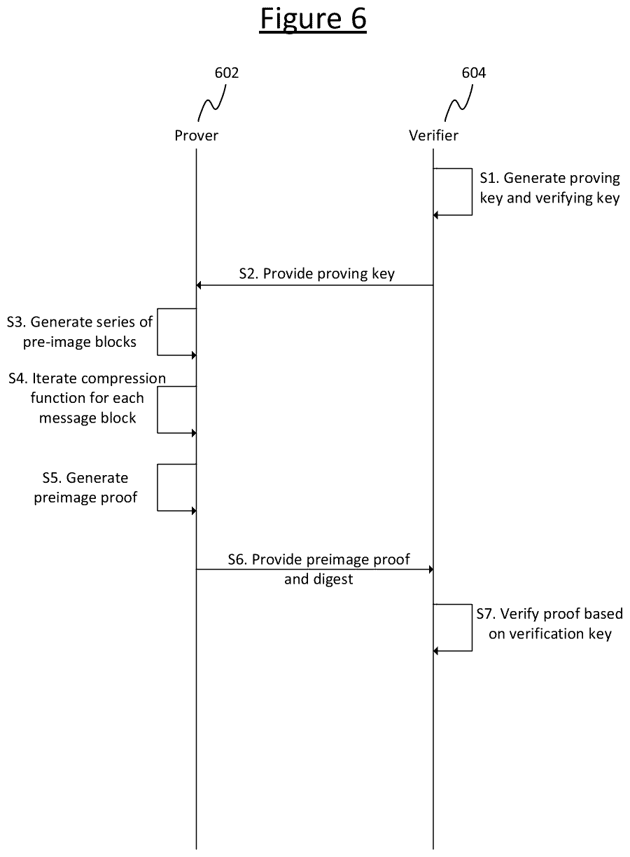

FIG. 6 shows an example method for proving a prover 602 has knowledge of a pre-image M without revealing the pre-image to a verifier 604.

At step 1, the verifier 604 executes Genₚᵣₑᵢₘ to generate the proving key pk and the verifying key vk based on the compression function. The compression function being used is known to both the prover 602 and the verifier 604. The verifier 604 provides, or otherwise makes available, the proving key pk to the prover 602 at step 2.

The prover 602 generates the series of pre-image blocks M⁽¹⁾ at step 3. The prover 602 may also generate the padding block if required at this step.

At step 4, the prover 602 iterates the compression function and generate, for each iteration, a corresponding proof that the compression function as been correctly executed. Each iteration is executed as a node 402, 304, 306 of the transcript 400, as described above. The output proof of the final node 306 is set as the preimage proof at step 5.

The prover 602 provides the preimage proof and the next state generated by the final node 306, which is the message digest H, to the verifier at step 6. The verifier 604 executes Verifyₚᵣₑᵢₘ using the received preimage proof and digest, and the verifier key, to verify that the proof is valid for the digest, and therefore verify that the prover 602 kas knowledge of the message M.

Although shown as a single entity, it will be appreciated that the prover 602 may comprise multiple computing devices, each comprising a processor. Each of the computing devices of the prover 602 may be configured to execute one or more nodes of the transcript 400. The outputs of each node may be sent to a processor of the prover 602 for inputting to the next node.

### 6.2 Patterns in SHA2 Preimages

The method set out above can be modified to prove that a pattern is present in a preimage of a given digest d. As an example, it may be possible to prove the statement “the first and last bits of the preimage of d are equal to 1”. In general, the method set out below provides a method for proving any bit pattern in the preimage M of a digest d and verify the enforcement knowing only d but not M.

### 6.2.1 Patterns

We start defining how we see patterns and how we compute short descriptions (summaries) of patterns.

A pattern [symbol] is represented as two [symbol] -bit vectors [symbol] :=(P:=(P₁, . . . , [symbol] ), C:=(C₁, . . . , [symbol] )), the first vector P is the pattern, and the second vector C are check bits. An [symbol] -bit string M is consistent with the pattern if whenever bit Cᵢ=1 we have Mᵢ=Pᵢ. The vector P can take any value on the bits that are not checked, for example, set all non-checked bits of P to zero. That is, the check bit vector C defines which bits of the message are checked, i.e. compared to the pattern vector P.

Definition 2 (Patterns and summaries). Let k be a security parameter and [symbol] , N, m be integers such that Nm≥ [symbol] . Let Hash:{0,1}^{2m+k}→{0,1}^{k} be a collision resistant hash function. An [symbol] -pattern [symbol] is a pair of [symbol] -bit vectors [symbol] :=(P:=(P₁, . . . , [symbol] ), C:=(C₁, . . . , [symbol] )).

Let \hat{P}=\hat{P}⁽¹⁾∥ . . . ∥\hat{P}^{(N)}) be an Nm-bit array split into m-bit blocks obtained from [symbol] by setting the iⱼ-th bit to pⱼ if Cⱼ=1, and zero elsewhere. Likewise, let Ĉ=Ĉ⁽¹⁾∥ . . . ∥Ĉ^{(N)}) be the result of splitting C into m-bit blocks and padding the last one with zeros if necessary. Let S⁽⁰⁾ be an arbitrary k-bit string. A summary of [symbol] is a k-bit string Summary ( [symbol] ):=S∈{0,1}^{k} such that:

$$S := Hash ( {\hat{P}}^{( N )} , {\hat{C}}^{( N )} , Hash ( {\hat{P}}^{( N - 1 )} , {\hat{C}}^{( N - 1 )} , Hash ( … Hash ( {\hat{P}}^{( 1 )} , {\hat{C}}^{( 1 )} , {S}^{( 0 )} ) … ) ) ) )$$

\hat{P} may be referred to herein as a bit pattern array, comprising a series of bit pattern array blocks \hat{P}⁽ⁱ⁾. Ĉ may be referred to herein as a check bit array, comprising a series of check bit array blocks Ĉ⁽ⁱ⁾.

Remark. Like SHA2, the construction of a summary S follows the Merkle-Damgard construction. Thus, the i-th intermediate state S⁽ⁱ⁾ of the summary can be computed from the i-th blocks P⁽ⁱ⁾, C⁽ⁱ⁾ and the (i−1)-th intermediate state S⁽ⁱ⁻¹⁾. Namely, S⁽ⁱ⁾:=Hash(P⁽ⁱ⁾,C⁽ⁱ⁾,S⁽ⁱ⁻¹⁾).

### 6.2.3 The Statement

The method provided herein proves following statement:
“Let (H, [symbol] ), then H is the digest of a message M consistent with pattern P”.

More formally, a proof system is provide herein to prove instances (H, [symbol] ) of the following relation:

$${ℛ}_{SHA 2 pattern} := \{ ( ( H , 𝒫 := ( P , C ) ; M ) \vert H = SHA {2}_{d , m , IV} ( M ) ⋀ {M}_{i} = {P}_{i} if {C}_{i} = 1 \} .$$

The length [symbol] of the preimage M is given by the length of the pattern vectors [symbol] .

6.2.4 Computation Transcript and Compliance

Replacing patterns by summaries to prove variable-length statements. The underlying PCD scheme defined herein is suitable for use with summaries of patterns instead of working with the full description [symbol] . Note that to enforce a pattern [symbol] on the i-th message block of a SHA2 preimage, only the i-th vectors P⁽ⁱ⁾, C^{(t)} of [symbol] need to be known. Nevertheless, to ensure that P⁽ⁱ⁾, N⁽ⁱ⁾ are part of the original public pattern [symbol] , the previous message blocks must have been enforced against the previous vectors of [symbol] (and not against some other pattern).

To do so, all i−1 preceding vectors of [symbol] could be passed as input to the compliance predicate and output for next iterations. However, this method would need as many compliance predicates as N (each of them takes inputs of different length), and preimages of different lengths would need different number of compliance predicates. The latter means it would not be possible to use the same SNARKₚₐₜₜₑᵣₙ scheme to prove patterns on any two preimages.

To overcome this problem, the i−1 intermediate state of the summary are passed, and to check consistency preceding pattern blocks, correct generation of the next summary state is enforced. Observe that all S⁽ⁱ⁾ has fixed length k, so a single compliance predicate suffices.

The actual construction. The transcript for checking patterns is defined very similarly as those for SHA2 preimages (see section 6.1.2). The differences are in the internals of the constraint predicate \vec{Π}ₚₐₜₜₑᵣₙ=(Π′ᵢₙᵢₜ,Π′_{update},Π′_{digest}) and the edge and node data. Concretely:
The i-th node (iteration) receives as local data the i-th m-bit blocks of \hat{P} and Ĉ; this is in addition to receiving the i-th message block. Thus z_{loc}:=(M⁽ⁱ⁾,\hat{P}⁽ⁱ⁾,Ĉ⁽ⁱ⁾). Further, edge message (outgoing data) now contains the i-th intermediate state of the summary; this is in addition to the i-th intermediate state of the SHA2 digest and the iteration counter. Thus zᵢₙ:=(iᵢₙ,Hᵢₙ,Sᵢₙ) and zₒᵤₜ:=(iₒᵤₜ,Hₒᵤₜ,Sₒᵤₜ).
Calls to the internal subroutine Φₑᵥₐₗ in the predicates Πₚᵣₑᵢₘ:=(Πᵢₙᵢₜ,Π_{update},Π_{digest}) from section 6.1.2 are replaced with calls to subroutine Φₚₐₜₜₑᵣₙ defined below. It is noted that the subroutine Φₑᵥₐₗ is performed as one of the steps of the subroutine Φₚₐₜₜₑᵣₙ.

The following table provides the predicate to ensure pattern consistency used internally as a subroutine in \vec{Π}ₚₐₜₜₑᵣₙ:=(Π′ᵢₙᵢₜ,Π′_{update},Π′_{digest}). Strings Ĉ, \hat{P} are computed as per Definition 1.

Φₚₐₜₜₑᵣₙ ((iᵢₙ, HᵢₙSᵢₙ), M, Ĉ, \hat{P}, (iₒᵤₜ, HₒᵤₜSₒᵤₜ)):
1. Check that Sₒᵤₜ := Hash(Ĉ, \hat{P}, Sᵢₙ)
2. If Ĉᵢ = 1 check that \hat{P}ᵢ = Mᵢ
3. Check that Φₑᵥₐₗ((iᵢₙ, Hᵢₙ), M, (iₒᵤₜ, Hₒᵤₜ)) accepts.
4. If the three checks accept, output “accept”. Else output “reject”.

That is, each node 304, 306, 402 is configured to execute a pattern check as well as the compression function check set out above.

Each node receives, as additional inputs, the bit pattern array block and the check bit array block corresponding to the block. Each node generates a next summary value Sₒᵤₜ and check that the next summary value is correctly evaluated by generating a hash based on a current summary value Sᵢₙ, the bit pattern array, and the check bit array.

The nodes 304, 306, 402 also check the pattern of the message block they are processing using a respective check bit array block and bit pattern array block. That is, the i-th message block M⁽ⁱ⁾ is compared to the i-th bit pattern array block P⁽ⁱ⁾ based on the i-th check bit array block C⁽ⁱ⁾.

Optimizing the size of Φₚₐₜₜₑᵣₙ. A zero-knowledge friendly hash function Hash can be used to calculate the pattern summary. This will keep the size of the compliance predicates \vec{Π}ₚₐₜₜₑᵣₙ tightly related to the size of \vec{Π}ₚᵣₑᵢₘ. For example, Pedersen hash has a R1CS of 2753 constraints. Poseidon has 316 constraints. On the downside, the cryptanalysis of these new constructions is less studied than the compression function of SHA2.

### 6.2.5 the Snarks

Let ( [symbol] ₚₐₜₜₑᵣₙ, [symbol] ₚₐₜₜₑᵣₙ, [symbol] ₚₐₜₜₑᵣₙ) be a PCD scheme to prove \vec{Π}ₚₐₜₜₑᵣₙ-compliance of messages. The proof system SNARKₚₐₜₜₑᵣₙ:=(Genₚₐₜₜₑᵣₙ,Proveₚₐₜₜₑᵣₙ,Verifyₚₐₜₜₑᵣₙ) is defined similarly to the previously described preimage proof system.

The verifier 604 generates the proving key and verifying key as set out about. The proving key is then provided to the prover 602 for use in proving knowledge of the preimage M. At each compression function iteration, the prover 602 also computes the corresponding state of the pattern summary S.

The output provided by the final node 306 of the transcript comprises the final state H^{(N)} (the digest H), the final summary S^{(N)} (the pattern summary Summary(P)), and the pattern proof πₚₐₜₜₑᵣₙ. This is provided to the verifier 604, which verifies the pattern proof based. In this method, zₒᵤₜ.payload=(H,Summary( [symbol] )), and the verifier 604 runs [symbol] ₚₐₜₜₑᵣₙ to validate the given proof πₒᵤₜ for zₒᵤₜ.

### 6.3 Merkle Tree Statements

Let [symbol] be an NP language. The following method provides a method for proving the following statement:
“Let H be a byte array and e be a non-zero positive integer. Then H is the root of a Merkle tree of depth e whose leaves are in [symbol] ”.

Thus, a statement about all the leaves can be proved.

Proving Merkle tree statements by sending the leaves is not efficient: first, the tree would need to be constructed to check against the given root, and second, 2^{e} proofs would need to be verified—one per leaf—for the base relation [symbol] _{b}. For example, for trees storing a million leaves of 1 MB each, at least 1 TB (accounting only for the leaf data, not the proofs) would need to be sent, which is inefficient, and may not be possible. The situation is similar with smaller trees storing larger data sets.

More formally, given a relation [symbol] _{b} for the leaves, a succinct proof system for the following relation is provided:

$${ℛ}_{tree , {ℛ}_{b}} := \{ ( H , e ) ; ( ( {L}_{1} , {w}_{1} ) , … , ( {L}_{{2}^{e}} , {w}_{{2}^{e}} ) ) \vert \begin{matrix}H = GetRoot ( {L}_{1} , … , {L}_{{2}^{e}} ) , \\ ( {L}_{i} , {w}_{i} ) ∈ {ℛ}_{b} ∀ i \leq {2}^{e}\end{matrix} \}$$

Variable-length statements. The depth e of the tree is not specified by the relation but instead it is part of the instance. Thus, [symbol] contains Merkle trees of arbitrary depth, which in turn means that the proof system SNARKₘₑᵣₖₗₑ, described below, that can prove arbitrarily-many instances of the base relation [symbol] _{b}.

6.3.1 Bootstrapping from Relation on Leaves to Merkle Tree

Start from leaves L₁, . . . , L₂_{^{e}}, all being instances of the base relation [symbol] _{b}, and consider the transcript arising from computing the circuit GetRoot on input L₁, . . . , L₂_{^{e}}. A source (leaf) node takes as input the leaf and hashes it. The other (non-leaf) nodes take as input two digests (from two child nodes) and hash them. Since [symbol] _{b} is in NP it admits a SNARK, so the circuit can be modified as follows. A source node receives as input the data L and a valid proof π_{b} attesting to the veracity of the statement “L∈ [symbol] ,”. This means that the complexity of the SNARK prover for [symbol] only depends on the complexity of the base SNARK verifier and Hash.

Remark 1. The approach provided herein precomputes the leaves proofs π_{b}. Another possibility is to assume the base relation has a PCD scheme with predicate vector \vec{Π} and augment \vec{Π} to accommodate for the circuit GetRoot. However, the resulting prover might be more complex.

Remark 2. A pre-processing (succinct) verifier for the base relation [symbol] _{b} that takes as input a verification key vk to verify a proof π_{b} is used. Thus, a SNARK for the following relation is provided:

$${ℛ}_{tree , {vk}_{{ℛ}_{b}}}^{′} := \{ ( H , e ) ; ( ( {L}_{1} , {π}_{b , 1} ) , … , ( {L}_{{2}^{e}} , {π}_{b , {2}^{e}} ) ) \vert \begin{matrix}H = GetRoot ( {L}_{1} , … , {L}_{{2}^{e}} ) , \\ verify ( {vk}_{{ℛ}_{b}} , ( {L}_{i} , {π}_{b , i} ) ) = “ accept ” ∀ i \leq {2}^{e}\end{matrix} \}$$

The verification key [symbol] for [symbol] _{b} is hard-coded in the description of

$${ℛ}_{tree , vk}^{′} .$$

The knowledge soundness of the SNARK verifier for [symbol] _{b} means that if

$$( H , e ) ∈ {ℛ}_{tree , vk}^{′} ,$$

then with high probability (H, e)∈ [symbol] . This is simply because with high probability the witnesses from valid proofs can extracted.

### 6.3.2 the Merkle Tree Computation Transcript

Let Hash: {0,1}^{2k}→{0,1} k be a cryptographic hash function. The compliance predicate vector is defined as \vec{Π}ₜᵣₑₑ:=(Π_{leaf},Πᵢₙₙₑᵣ) as follows.

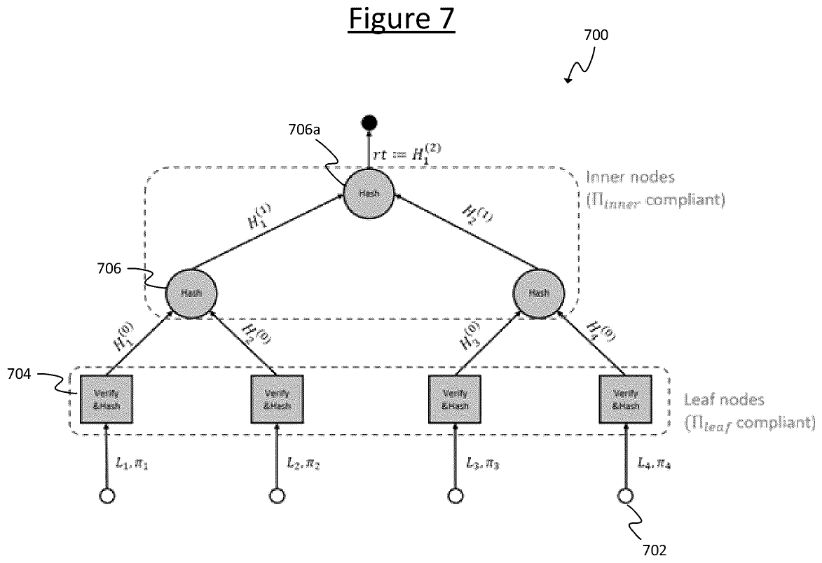

FIG. 7 provides an example Merkle tree 700 described herein. The Merkle tree 700 comprises four leaves 702, each defining leaf data, also referred to herein as a data block, Lᵢ and a corresponding data block proof πᵢ. The Merkle tree 700 comprises four leaf hash values to which each of four leaf nodes 704 is mapped respectively, wherein each leaf node 704 has an associated leaf 702 and is configured to receive the block data and the data block proof from the associated leaf 702. The Merkle tree 700 further comprises inner hashes to which inner nodes 706 are mapped. The nodes 704, 706 mapped to the Merkle tree 700 are arranged in layers, the nodes of each layer receiving, as inputs, outputs generated by a pair of nodes 702, 704 of the previous layer.

The data block proof πᵢ attests that the data block Lᵢ satisfies a predefined criterion. For example, the criterion may be that the data block matches a predefined pattern, as in section 6.2, wherein the data proof attests that the data block matches the pattern.

Each of the leaf nodes 704 receive a corresponding data block Lᵢ and it's associated data proof πᵢ. Each leaf node 704 verifies that the received proof πᵢ is valid, and hashes the received data block to generate a data block hash Hᵢ:=Hash(Lᵢ).

The inner nodes 706 of a first layer of inner nodes 706 each receive the data block hashes generated by two of the leaf nodes 704. These inner nodes 706 generate a hash of the data block hashes, referred to herein as an output hash, which is then provided to an inner node 706 of a next layer of the inner nodes 706.

This process is repeated, with each inner node 706 receiving two hash values generated by inner nodes 706 of a previous layer, until a final inner node 706a, arranged in a final layer of the nodes 704, 706 mapped to the Merkle tree 700 generates its hash value, which is a Merkle root of the Merkle tree 700.

Each of the nodes 704, 706 may also compute a proof.

Each leaf node 704 receives the data proof πᵢ associated with the received data block Lᵢ, and generates a leaf node proof attesting that the node outputs a hash of the input data and that the node has verified successfully the input data proof. That is, each leaf node proof attests to (1) the input leaf proof being valid (the verification algorithm outputs 1 on this proof), and (2) the output block hash is the hash of the input data. The leaf node proof, therefore, attests to both the data block Lᵢ being a leaf of the Merkle tree 700, and that the data block itself satisfies the predefined criterion.

Each inner node 706 of the first layer receives, with the leaf hashes, the corresponding leaf node proofs. These inner nodes 706 generate a proof, referred to herein as an output proof, based on the two received leaf node proofs. Each output proof attests to (1) the input proof is valid and (2) the output hash is the hash of the two input hashes.

In a similar manner to the generation of the output hashes, each leaf node 706 of each subsequent layer receives, as input, two output proofs generated by inner nodes 706 of the previous layer, corresponding to the received hashes. Each inner node 706 generates an output proof based on the two received proofs. In this way, each output proof attests to the block data values and the previous hashes being present, and that the leaf data block satisfies the criterion.

The output proof generated by the final node 706a attests that the output hash is the root of Merkle tree whose leaves satisfy the criterion. This output proof may be referred to herein as a Merkle tree proof for the Merkle tree 700.

The nodes 704, 706 may be executed by the same computing device. Alternatively, one or more of the nodes may be executed by different computing devices. In this embodiment, the output hashes and proofs are sent between the computing devices for generating the Merkle tree proof and Merkle root. Code defining the Merkle tree may be split into portions, each portion defining one of the nodes 704, 706 of the Merkle tree 700, and each computing devices storing and executing one or more portions of the code, corresponding to the node(s) 704, 706 being executed by the computing device.

Leaf nodes 704 (type 1). Leaf nodes 704 take the data L∈{0,1}^{2k} and data proof π_{b} for statement L∈ [symbol] as input zᵢₙ, computes the leaf hash H:=Hash(L) and outputs zₒᵤₜ:=(H,0). If L has m<2k bits, right pad with 2k-m zeros before hashing. All these checks are encoded in predicate Π_{leaf}. Concretely, the validity of π_{b} is enforced with the circuit of the SNARK verifier for the base relation (the verification key it is hardcoded in the circuit), and correctness of H with the circuit for Hash.

Inner nodes 706 (type 2). Inner nodes 706 take two inputs

$${z}_{in}^{( l )} := ( {H}^{( l )} , e - 1 ) and {z}_{in}^{( r )} := ( {H}^{( r )} , e - 1 ) ,$$

where e≥1 denotes a depth of the inner node 706 in the Merkle tree 700, and H^{(l)},H^{(r)}∈{0,1}^{k}. Compute H:=Hash(H^{(l)}∥H^{(r)}) and output zₒᵤₜ:=(H,e). If e=1, the inputs come from two leaf nodes 702. Else, the input comes from inner nodes 704 of a previous layer. All these checks are encoded in predicate Πᵢₙₙₑᵣ.

Hashing leaf data with size>2k The domain of Hash is fixed to 2k. If the leaf Lᵢ is of large size>k, it can be double hashed. Thus,

$${H}_{i}^{( 0 )} := Hash ( {Hash}_{var} ( {L}_{i} ) ) .$$

Hashᵥₐᵣ is set to a cryptographic hash for which it is possible to prove knowledge of preimages incrementally (for example, SHA2 with the SNARK from section 6.1.3). The inputs proofs πᵢ attest to a statement “Given public

$${L}_{i}^{*} ∈ {\{ 0 , 1 \}}^{*}$$

there exists Lᵢ, wᵢ such that

$${L}_{i}^{*} = {Hash}_{var} ( {L}_{i} )$$

and (Lᵢ,wᵢ)∈ [symbol] _{b}. Observe that leaf data is not necessarily of the same size |Lᵢ|≠|Lⱼ|.

The choice of the hash function. As in the case of proving patterns in SHA2 preimages, a zk-friendly hash function, like Pedersen hash or Poseidon, can be used in the Merkle tree construction. It will be appreciated that any hash function may be used.

### 6.3.3 the Snarks Proof System

Let ( [symbol] ₘₑᵣₖₗₑ, [symbol] ₘₑᵣₖₗₑ, [symbol] ₘₑᵣₖₗₑ) be the PCD scheme that proves that output (H, e) is (\hat{Π}₁,\hat{Π}₂)-compliant and let (G_{b},P_{b},V_{b}) be the base SNARK verifier. The SNARK proof system for relation [symbol] _{tree,R}_{_{b}} is the triplet SNARKₘₑᵣₖₗₑ:=(Genₘₑᵣₖₗₑ,Proveₘₑᵣₖₗₑ,Verifyₘₑᵣₖₗₑ).

Genₘₑᵣₖₗₑ(λ, [symbol] _{tree,R}_{_{b}})→(pk,vk):
1. Generate keys for the base SNARK (pk_{b},vk_{b}):=G_{b}(λ, [symbol] _{b})
2. Generate keys for the Merkle tree PCD (pk_{pcd}, vk_{pcd}):= [symbol] ₘₑᵣₖₗₑ(λ,\hat{Π}₁,\hat{Π}₂).// Predicate \hat{Π}₁ has the base verification key vk_{b} hardcoded in it.
3. Output pk:=(pk_{pcd},pk_{b}), vk:=vk_{pcd}
   Proveₘₑᵣₖₗₑ(pk,(H,e),(L₁, w₁ . . . , L₂_{^{e}},w₂_{^{e}}))→πₘₑᵣₖₗₑ:
1. Parse pk:=(pk_{pcd},pk_{b})
2. For i=1 to 2^{e} compute π_{b,i}:=P_{b}(pk_{b},Lᵢ,wᵢ)//Offline prover
3. Compute the output proofs of leaf nodes. For i=1 to 2^{e} do://A total of 2^{e} leaf nodes.
   a. Let Lᵢ,π_{b,i} be the i-th leaf data and valid proof for the leaf relation [symbol] _{b}. Set input of leaf node z_{in,i}.payload:=(Lᵢ,π_{b,i}), and z_{in,i}· type=0 (source node).
   b. Let set output node

$${z}_{i}^{( 0 )} := Hash ( {L}_{i} ) ,$$

set output node

$${z}_{o u t , i} \cdot payload := ( {z}_{i}^{( 0 )} , 0 )$$

and z_{out,i}.type=0 (leaf node).

$${π}_{i}^{( 0 )} := {ℙ}_{merkle} ( p {k}_{pcd} , {z}_{out , i} , ( {z}_{loc} := ⊥ , {z}_{in , i} , {π}_{in , i} := ⊥ ) )$$

4. Compute the output proofs of inner nodes. Repeat for d=1, . . . , e//From layer d−1 to layer d.
   a. Take as input 2^{e-(d-1)} pairs of inputs/proofs

$${( ( {z}_{2 k - 1}^{( d - 1 )} , {π}_{2 k - 1}^{( d - 1 )} ) , ( {z}_{2 k}^{( d - 1 )} , {π}_{2 k}^{( d - 1 )} ) )}_{k = 1}^{{2}^{e - ( d - 1 ) - 1}}$$

b. Take 2^{e-d} node output payload:

$${( {z}_{k}^{( d )} := Hash ( {z}_{2 k - 1}^{( d - 1 )} , {z}_{2 k}^{( d - 1 )} ) )}_{k = 1}^{{2}^{e - d}}$$

//Note that

$${z}_{1}^{( e )} := H$$

c. For k=1 to 2^{e-d} do:
   i. Set input data to

$${\vec{z}}_{i n , k} \cdot payload := ( {z}_{2 k - 1}^{( d - 1 )} , {z}_{2 k}^{( d - 1 )} , d - 1 ) .$$

The type of the input nodes is 1 (leave nodes) if d=1. Else the type is 2 (inner nodes).
ii. Set input proofs to

$${\vec{π}}_{i n , k} := ( {π}_{2 k - 1}^{( d - 1 )} , {π}_{2 k}^{( d - 1 )} )$$

iii. Set

$${z}_{o u t , k} := ( {z}_{k}^{( d )} , d )$$

iv. Compute the output proofs

$${π}_{k}^{( d )} := {ℙ}_{merkle} ( p {k}_{pcd} , {z}_{k}^{( d )} , ( {z}_{l o c} := ⊥ , {\vec{z}}_{i n , k} , {\vec{π}}_{in , k} ) )$$

d. Output

$${π}_{merkle} := {π}_{1}^{( e )}$$

Verifyₘₑᵣₖₗₑ(vk,(H,e),πₘₑᵣₖₗₑ)→{“accept”,“reject”}. It takes as input a verification key vk, a digest and tree depth (H,e) and a proof πₘₑᵣₖₗₑ. Acceptance means that H is the root of a Merkle tree of depth e whose leaves are instances of [symbol] _{b}.
Steps:
   1. Interpret vk as vk_{pcd}
   2. Set zₒᵤₜ.type:=2 (inner node) and zₒᵤₜ.payload:=(H,e)
   3. Run [symbol] ₘₑᵣₖₗₑ(vk_{pcd},zₒᵤₜ,πₘₑᵣₖₗₑ). If it accepts, output “accept”. Else output “reject”.

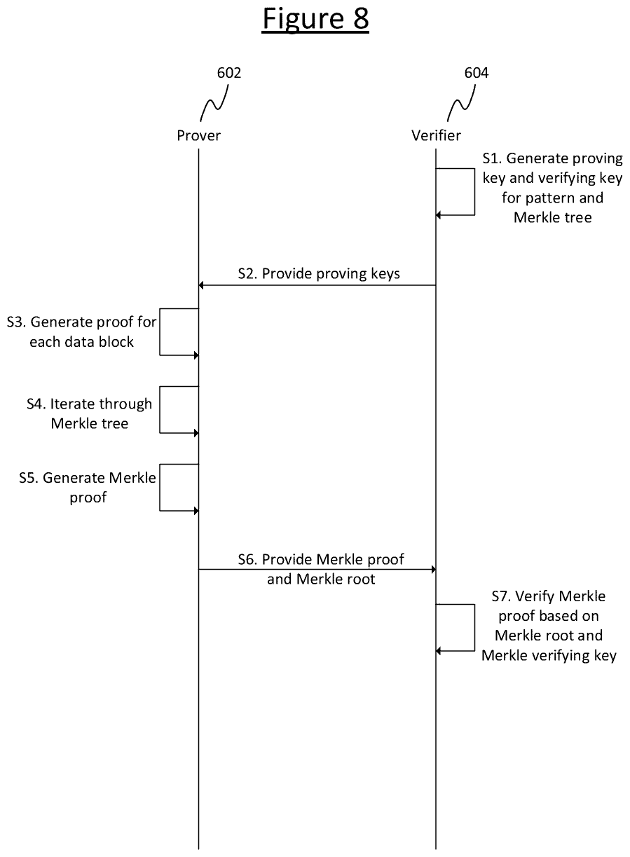

FIG. 8 shows an example method for proving each data block Lᵢ satisfies a criterion. In the example of FIG. 8, the criterion is a predefined pattern.

At step 1, the verifier 604 generates a proving key pk_{b} and verifying key vk_{b} for the criterion that the leaf data must satisfy. The verifier also generates a proving key pk_{pcd} and verifying key vk_{pcd} for the Merkle tree 700. The two proving keys pk_{b},pk_{pcd} are sent, or otherwise made available, to the prover 602 at step 2.

The prover 602 generates data proofs for each of the data blocks at step 3. In order to generate the proofs, the prover 602 compares the bits of each data block Lᵢ defined by the respective check bit array block Cᵢ to those of the respective pattern bit array block Pᵢ. If the bits match, the data block satisfies the pattern criterion and thus the proof can be generated.

At step 4, the prover 602 iterates through the Merkle tree 700. That is, the prover 602 executes the leaf nodes 704 and inner nodes 706 to generate the Merkle root and Merkle tree proof, step 5, as generated by the final node 706a.

The prover 602 sends both the Merkle tree proof πₘₑᵣₖₗₑ and the Merkle root H to the verifier 604 at step 6. The verifier 604 uses the Merkle root and the Merkle root verifying key (generated in step 1) to verify the received Merkle tree proof at step 7. In this way, the verifier 604 is satisfied that the data blocks used by the prover 602 to generate the Merkle root and Merkle tree proof satisfy the pattern criterion.

It will be appreciated that the criterion that the data blocks Lᵢ must satisfy may be any criterion for which a zero-knowledge proof can be generated.

### 6.3.4 Proof Aggregation and Universal Trees

The design set out above has two important properties.

Aggregating proofs. Two proofs

$${π}_{merkle} , {π}_{merkle}^{′}$$

for (H,e), (H′,e′) with e=e′, i.e. the Merkle trees have the same depth, can be merged and a proof π″ₘₑᵣₖₗₑ for (H″:=Hash(H,H′),e+1) produced with a single invocation of the PCD prover [symbol] ₘₑᵣₖₗₑ. Note that H″ is the root of a Merkle tree whose 2^{e+1} leaves are in the base relation [symbol] _{b}. If the tree depths are different, say e<e′, the smaller tree can be replicated with 2^{e′-e} dummy leaves to generate an augmented tree of depth e′ with root H_{replicated} and then both proofs merged. Correct augmentation of the smaller tree can also be proved incrementally.

Proving arbitrary base relations. The relation

$${ℛ}_{tree , {vk}_{{ℛ}_{b}}}^{′}$$

has the verification key [symbol] for a specific relation [symbol] _{b} hard-coded as part of its description. The description of

$${ℛ}_{tree , vk}^{′}$$

can be decoupled from [symbol] _{b} using a universal SNARK for the base relation [symbol] _{b}. In a universal SNARK, there exist a public procedure specialize that takes a circuit-independent (universal) verification key vk and produces a circuit-specific verification key [symbol] . Therefore, the universal vk can be hard-coded in the circuit and correct specialization to [symbol] proved as a circuit gadget. This allows the circuit-specific verification key [symbol] to be seen as part of the instance. In other words, with a single SNARK proof system, leaves of a Merkle tree can be proven to be on arbitrary NP languages. The universal tree relation is:

$${ℛ}_{tree , vk}^{′} := \{ ( H , e , {vk}_{{ℛ}_{b}} ) ; ( ( {L}_{1} , {π}_{b , 1} ) , … , ( {L}_{{2}^{e}} , {π}_{b , {2}^{e}} ) ) \vert \begin{matrix}\begin{matrix}H = GetRoot ( {L}_{1} , … , {L}_{{2}^{e}} ) , \\ {vk}_{{ℛ}_{b}} = specialize ( vk )\end{matrix} \\ verify ( {vk}_{{ℛ}_{b}} , ( {L}_{i} , {π}_{b , i} ) ) = {}^{″} {accept}^{″} ∀ i \leq {2}^{e}\end{matrix} \}$$

Therefore, this removes the requirement for the verification key to be changed if the circuit is changed.

### 6.4 Possible Modifications

Patterns in intermediate hash states. The idea from Section 6.2 can be used to prove patterns in intermediate states H⁽ⁱ⁾. An (inner) compliance predicate Φ_{midstatePattern} of the i-th node may enforce consistency of the outgoing midstate H⁽ⁱ⁾ with the pattern [symbol] . In particular, it can be proven that a given d-bit string H_{mid} is the i-th midstate of a given digest H.

Proving keyword search or that a string does not appear in a preimage. It is possible to show that a given short string S of at most m bits appear in some of the SHA2 message blocks (or that it does not appear). The idea for the compliance predicate is to loop m-p times over 1-right shifts of the string S and check if it matches the corresponding p-bits slice of the message block. For example, this can be used to prove that a transaction with identifier TxID of unknown size is a P2PKH transaction matching against the pattern of the P2PKH script (4 bytes), or to prove that it does not contain embedded data showing that the 2-byte string “OP_FALSE OP_RETURN” in the serialization of the transaction.

Variable size Merkle tree proof. Statements of the form “Given public (H, e, L, i) I known an authentication path ap proving that L is the i-th leave of a Merkle tree with root H and depth e. Furthermore, I know a witness w such that L is an instance of [symbol] _{b}” can also be considered. Similar to Merkle tree statements from section 6.4, the private authentication path is of variable size. This can be used in zk-rollups where accounts are the leaves of Merkle trees, and account transfers implies proving knowledge of Merkle tree proofs.

Variable size Merkle tree proofs allows zk-rollups to handle batches of different sizes (i.e., the batch size is independent of the instantiation of the underlying SNARK system).

Relation of the leaves depend on their position on the tree. Thus, i-th leaf and j-th leaf are instances of [symbol] _{b,i} [symbol] _{b,j} respectively (not necessarily the same relation).

### 7. APPLICATIONS

Some example applications for the above mentioned zero-knowledge proof systems are provided. It will be appreciated that these examples are non-limiting. The above-mentioned proof systems are particularly useful for applications in which large data is encrypted. In known methods, proving correct encryption of the data requires multiple iterations, which is both time and computationally inefficient, and may even be impossible for some data sizes.

This problem is overcome by the above methods by hashing the data and proving the prover has knowledge of the pre-image of the hash.

### 7.1 Scalable Zero-Knowledge Contingent Payments

Maxwell's contingent payment scheme. A zero-knowledge contingent payment scheme (ZKCP) as known in the art works in two steps:
(1) The buyer Alice specifies the requirements of the data she wants to buy, say that Φ(data, public)=1.
(2) The seller Bob sends a (symmetric) ciphertext ct and a digest d along with a zkSNARK proving that the ciphertext encrypts data consistent with the buyer's requirements and that the symmetric key used for encryption is the preimage of the transmitted digest.

Once the buyer verifies the zkSNARK, he sets up a hash-time lock (HTLC) transaction on the BSV blockchain with the agreed amount using the digest d. When the seller redeems the funds, he also reveals the symmetric key (the preimage of the digest) and the buyer can decrypt the purchased data.

Real use cases examples of large data sets include:
Movies in HD format (or non-lossy formats),
complex proprietary software.

The requirement imposed in both cases is that their SHA256 digest equals some known bitstring h*. Thus Φ(data, h*)=1 iff SHA256(data)=h*.

The source of inefficiency. The problem with this approach is that if the data is large (as in the above examples) proving in zero-knowledge correct evaluation of the encryption circuit monolithically is expensive. Encrypting just 1 MB of data using a 128-bit block cipher in counter mode, like AES-CTR, requires 65536 iterations over the block cipher.

The solution. Encryption of the data is incrementally proven. Since the prover is incremental, it can handle arbitrarily large data in a scalable way. In more detail, data is encrypted with a one-time-pad (OTP) encryption scheme. The OTP takes keys as long as the data. To avoid redeeming HTLC transactions with excessively large keys, a key stretching step can be introduced. Thus, the data is encrypted with output keying material okm which is the expansion of a short (say 128 or 256 bits) input keying material ikm using a key derivation function (HKDF).

HKDF is known in the art and therefore will not be described in detail herein. In summary, HKDF comprises two steps. In a first step, a fixed-length pseudorandom key prk is extracted from the input keying material ikm. This step may be implemented by a HMACₑₓₜ node 906. In a second step, the fixed-length pseudorandom key is expanded into several additional pseudorandom keys Hᵢ. The step may be implemented by multiple HMACₑₓₚ nodes 908. The output keying material okm comprises these additional pseudorandom keys Hᵢ.

What is put on-chain is the hash of the (short) ikm. That is:

$$ct := data ⊕ okm ,$$

$$okm := HKDF ( ikm ) ,$$

$$d := SHA 2 ( ikm ) .$$

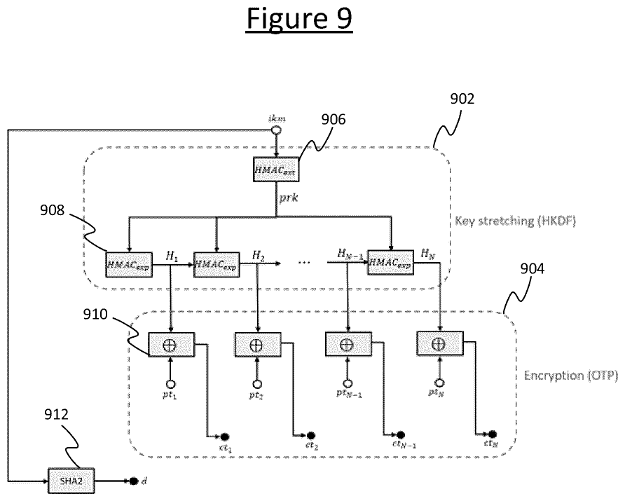

FIG. 9 shows a \vec{Π}-compliant transcript for multi-predicate \vec{Π}:=(Π_{HMAC}_{ₑₓₜ},Π_{HMAC}_{ₑₓₚ},Π_{OTP},Π_{SHA2}) for efficient and scalable ZKCP. Source nodes are denoted with white circles and output nodes with black circles. The data is data:=(pt₁, . . . , pt_{N}) and the resulting ciphertext is ct:=(ct₁, . . . , ct_{N}). ptᵢ and ctᵢ are h-bit blocks where h is the range of the underlying hash function used in HKDF and N:=[dataLength/h].

The improvements provided by this method are twofold.
1) Recursive zkSNARKs are used to incrementally prove correct encryption of the data. This means that hardware requirements of the prover can be very limited even when working with large data. More specifically, correct hashing of the input keying material ikm and xoring of the data and the output keying material okm are incrementally proven. The transcript to prove is depicted in FIG. 9. This transcript distinguishes four types of nodes 906, 908, 910, 912. A key stretching sub transcript 902 corresponds to the computation of the HKDF and is carried out in the two types of HMAC nodes. The difference between these nodes is the size of their inputs. Namely, HMACₑₓₜ node 906 corresponds to the ‘extract’ step of HKDF, and HMACₑₓₚ nodes 908 to the loop of the ‘expand’ step. Both, the key stretching 902, and xoring transcripts 904 are data-length dependent, and this is where the incremental nature of the scheme is taken advantage of.
2) To further speed up the proving time (dominated by the number of constraints for circuits Π_{HMAC′}, Π_{HMAC}) a zero-knowledge friendly hash function (e.g., Pedersen or Poseidon) may be used in the HKDF calculation (at each HMAC node/iteration 906, 908) This speeds up proving time compared to proving compliance of transcripts arising from e.g., AES-CTR.

Reducing the number of output proofs. A PCD prover produces as many proofs as sink (output) nodes of the computation transcript. In FIG. 9, the N+1 output nodes can be collapsed into two nodes as follows. Each ct; is seen as as the i-th leave of a Merkle tree and then using the Merkle tree prover from Section 6.3, correct root generation and that leaves are of the right form can be proven. A verifier would receive the root node proof πₘₑᵣₖₗₑ, and the proof πₚᵣₑᵢₘ for the SHA2 node, and the ciphertext ct:=(ct₁, . . . , ct_{N}). To check well-formedness of ct, the verifier re-generates the Merkle root and verifies πₘₑᵣₖₗₑ on it. This compression also applies when incrementally proving data is encrypted with a block cipher.

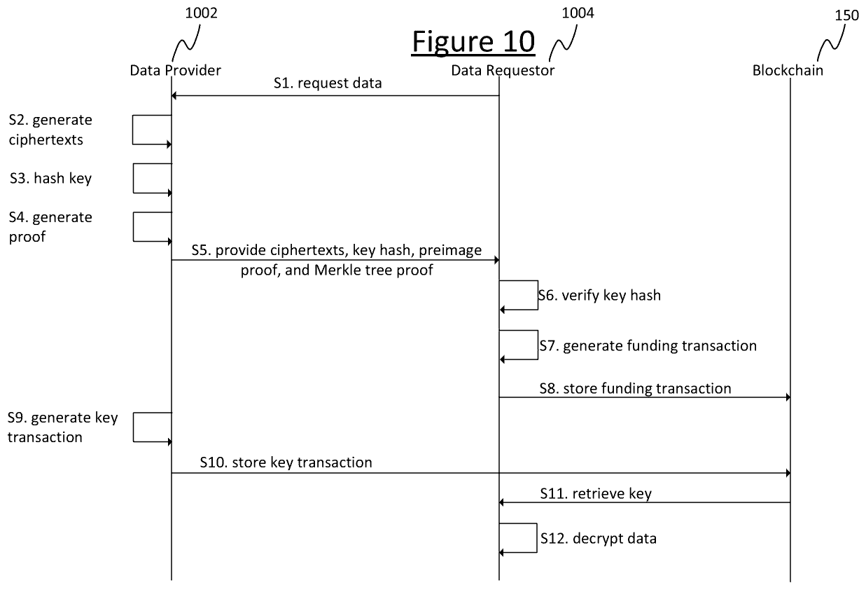

FIG. 10 provides an example method for the above-mentioned application. In the example of FIG. 10, a data requestor 1004 acts as the verifier 604 and a data provider 1002 acts as the prover 602.

At step 1, the data requestor 1004 requests data from the data provider 1002. The requested data may be any large data, such as an HD film file or a complex computer program. The data requestor 1004 also provides proving keys pk to the data provider 1002 for both the primage SNARK of section 6.1 and the Merkle tree SNARK of section 6.3. In some embodiments, a trusted third party provides the proving key pk to the data requestor 1004. The trusted third party provides the verifying key vk, corresponding to the proving key pk, to the data provider 1002, and may also provide to the data provider 1002 the proving key pk. In this way, a malicious data requestor 1004 cannot gain information on the data without purchasing it just by inspecting the zk proof, generated using a faulty proving key, provided by the data requestor 1004, for which zero-knowledge is not preserved.

The data provider 1002 selects input keying material ikm, derives the output keying material okm using the HKDF, and generates the ciphertexts ct; for the requested data using the output keying material, step 2. The input keying material may be referred to herein as a data encryption key.

It will be apricated that the data provider 1002 may derive the output keying material okm prior to receiving the data request. The data provider 1002 may also have derived the ciphertexts prior to the data request, such that the data provider 1002 stores the ciphertexts, in association with the data, in a memory for retrieval when a request for the data is received. The private information required to generate the proof may also be stored in association therewith.

The data provider 1002 also computes a hash of the input keying material ikm to compute a digest d, also referred to herein as a key hash, step 3. As above, the data provider 1002 may derive the digest prior to receiving the data request and store the digest in a memory.

The data provider 1002 generates a proof, based on the proving key pk, which attests to both the preimage and the ciphertexts. In this way, it is ensured that the ciphertext has been generated using, as a symmetric key, the preimage of the SHA2 digest, such that the proof guarantees that the ciphertexts and preimage of the digest are consistent. For example, the proof may comprise a preimage proof πₚᵣₑᵢₘ for proving, in zero-knowledge, that the input keying material ikm is the preimage of the digest d, and the Merkle tree proof πₜᵣₑₑ for proving the ciphertexts are generated correctly, step 4.

The data provider 1002 provides, or otherwise makes available, to the data requestor 1004, the ciphertexts corresponding to the requested data, the digest, and the proof, at step 5.

At step 6, the data requestor 1004 verifies the digest and the ciphertexts using the received proof and a verifying key.

If the data requestor 1004 is satisfied that the received ciphertexts and digest satisfy the requirements, the data requestor 1004 generates a funding transaction at step 7. The funding transactions provides in a UTXO the payment for exchanging for the data. This UTXO is locked to a key corresponding to the data provider 1002. The funding transaction may be an HTLC transaction and may be generated using the digest. The data requestor 1004 makes the funding available for storing to the blockchain 150 at step 8.

In order to provide the input keying material to the data requestor 1004, the data provider 1002 generates a key transaction, step 9. The unlocking script of the key transaction unlocks the UTXO of the funding transaction, and comprises the input keying material ikm, such that, when run together with the locking script of the funding transaction, the input material key is verified to be the preimage of the digest. In this way, the data provider 1002 provides the key required to decrypt the ciphertexts when they receive the funds for the data. The key transaction is stored to the blockchain 150 at step 10.

The data requestor 1004 retrieves the input keying material from the blockchain 150 at step 11, and uses it to decrypt the ciphertexts to acquire the requested data, step 12.

### 7.2 Fair and Private Digital Marketplaces

Atomic swaps between a buyer and a seller that simultaneously guarantees fairness and privacy is not possible without a trusted third party (TTP). Zero-knowledge contingent payments (ZKCP) leverage the blockchain as a TTP to realize such fair and private trades. However, these exchanges happen between two parties, which might not be very practical. A mediator—a digital marketplace—may put in contact both parties in exchange of a fee.

A digital market place. The following design of the digital marketplace may be used.
1. The seller generates a two-layer encryption of his data.

$$\begin{matrix}{ct}_{outer}^{( sellerID )} := {Enc}_{{k}_{outer}} ( data , {ct}_{inner} := {Enc}_{{k}_{inner}} ( data ) , d \\ := Hash ( {k}_{inner} )\end{matrix}$$

2. In addition, the seller generates a SNARK proof π^{(sellerID)} attesting for correct generation of the outer ciphertext above. Thus, concretely, the proof ensures (i) correct encryption of ctₒᵤₜₑᵣ, (in particular this implies knowledge of the used outer encryption key kₒᵤₜₑᵣ), (ii) Φ-compliance of the inner-encrypted data is for a given predicate Φ, and (iii) the outer ciphertext also encrypts a hash of the inner encryption key kᵢₙₙₑᵣ.
3. The marketplace maintains his database as a Merkle tree with leaves containing

$${ct}_{outer}^{sellerID}$$

from many sellers. Using the scheme from Section 3.3 it generates a proof πₘₑᵣₖₗₑ for the Merkle root attesting to the validity of all leaves.
4. The buyer fetches the tree and validates the root once and for all.
5. The buyer, at a later point says he wants to buy N items from seller sellerID. He contacts the seller and let him know his intention of buying the data items.
The seller sends the buyer, via a private channel, the out keys

$${k}_{outer}^{sellerID}$$

(potentially more than one).
7. The buyer decrypts the outer layers of each received ciphertext, obtaining N inner ciphertexts and hashed inner keys.

$${ct}_{inner} := {Enc}_{{k}_{inner}} ( data ) , d := Hash ( {k}_{inner} ) .$$

Note that the buyer implicitly verifies the N encrypted data items by verifying the (single) proof of the Merkle root in step 4.
8. The buyer and the seller leverage the blockchain to perform a fair and private atomic swap. (The Maxwell ZKCP protocol). Thus:
   a. The buyer sets a HTLC contract using the digest d. (In BSV this can be done with two transactions.)
   b. The seller redeems the funds by embedding in the unlocking script the inner key kᵢₙₙₑᵣ as the preimage of d.
   c. The buyer retrieves kᵢₙₙₑᵣ reading the blockchain and decrypts the compliant data.

Federation of digital markets. Several digital markets can federate. One entity, the data aggregator would aggregate proofs of the Merkle roots of all the markets, as explained in Section 6.3. Sellers and buyers need only to verify this single master root, and upload/download the data from different locations.

### 7.3 Partial Blockchain Redaction

A mechanism to prove correct transaction redaction can use a SNARK to prove that a public pattern appears in the preimage (the transaction) of a given TxID (the SHA256 digest). However, this proof scheme is not scalable: to show that a pattern spreading across each of the 512-bit blocks of the transaction, m proofs would need to be produced, where m is the number of blocks. For 1 MB transactions, this means verification of 16384 proofs.

Instead, the SNARK scheme of Section 6.2 can be used to generate a single proof, independently of the size of the transaction. The incremental computation nature of our SNARKs also means that for extremely large transactions (say 1 GB data) the prover can pause the proof generation and resume later where it left it.

### 7.4 Efficient Merklized Transactions

The identifier TxID′ of a transaction can be generated by ordering the fields as leaves of a Merkle tree and setting TxID′ to the root. Such a data structure allows inclusion of fields without revealing the entire transaction to be proven by sending the Merkle tree proof to the verifier.

The problem is again scalability when proving in zero-knowledge consistency of the Merklized identifier TxID′ and the standard identifier TxID that appears on-chain. There are at least as many leaves as inputs and outputs in the transaction. Since the number of I/O differ in each transaction, circuit-specific SNARKs (the most efficient) cannot be used and therefore universal SNARKs must be used instead. Further, proving consistency of identifiers for transaction with a large number of I/O is time and space consuming, perhaps beyond practical limits.

With the SNARK proposed in Section 6.3 (Merkle tree statements), consistency of both types of identifiers can be proven in a scalable way. Regardless of the number of I/O of each transaction and being able to choose a circuit-specific proof system (such as Groth16) if desired. The input proofs attached to each of the leaves of the tree is correct SHA2 hashing. Here as well it is possible to take advantage of the scalable scheme from Section 6.1 when e.g., dealing with leaf hashes of locking script fields containing large chunks of OP_RETURN data.

### 8. Further Considerations

### 8.1 A Comparison of Recursive Snarks

The following metrics are used to categorize existing preprocessing SNARKs with succinct verifiers.
Circuit-specific: Proving/Verification keys cannot be re-used for different circuits (NP-relations). If keys can be reused the scheme is universal.
Size of the argument: Small versus medium versus large. (The smaller the better.)
Prover runtime: Fast versus moderate versus slow.
Setup: Trusted versus updatable versus transparent setup.
   Trusted: The party that generates the proving and verification keys, or the structured reference string (SRS), is in possession of sensitive data that if disclosed publicly (in particular with the prover) the soundness of the scheme does not hold. Trusted setups must be executed in a controlled environment.
   Updatable: Anyone can update the structured reference string (SRS). This limits the risk of breaking soundness with a trusted setup as just the honesty of one updater suffices to maintain soundness (of proofs generated after the update takes place).
   Transparent: An untrusted party can generate the proving and verification keys, or the SRS.
Post-Quantum security: Whether the scheme is secure in the presence of a post-quantum computer.

| | Circuit | Argument | Prover | | Post-quantum |
|---|---|---|---|---|---|
| | specific | size | runtime | Setup | security |
| Groth16 | Yes | Small | Fast | Trusted | No*** |
| GM17 | Yes | Small | Fast* | Trusted | No**** |
| Marlin | No | Large | Slow | Updatable | No |
| Plonk | No | Medium | Moderate | Updatable | No*** |
| Sonic | No | Large | Slow | Updatable | No*** |
| Fractal | No | Large | Slow | Transparent | Yes** |

*GM17 verification consists of six pairings, which would incur in a more expensive recursive prover than Groth16, whose verification consists of four pairings (without precomputations).
**Security in ROM (not standard model)
***Security in the generic/algebraic group model (not great)
****GM17 has simulation-extractability, a better security guarantee than Groth16.

8.2 PCDs from Pairing-Based Snarks

Recursive proof composition, or proof carrying data, can be constructed from a base SNARK with a succinct verifier (an algorithm whose runtime is sublinear in the size of the circuit). It is not possible to have succinct verification without preprocessing: the verifier must at some point read the circuit whose correct evaluation is checking-either at preprocessing time or later when the instance of the relation is given. What preprocessing (i.e., an offline verifier) enables is the production of a short (sublinear) description of the circuit, namely the verification key. Such key is given to the online verifier along with the public input of the circuit.

Note. There are other approaches to construct PCDs that are not consider here. For example, via succinct accumulators, or for circuits whose description is much smaller than the actual computation.

### 8.2.1 The Circuits for the Compliance Predicates

Let the compliance predicates \vec{Π}:=(Π₁, . . . , Πₙ) of the computation transcript [symbol] . Each node shows compliance with its predicate Πᵢ by proving satisfiability of the template circuit Cᵢ shown below. This circuit besides checking that predicate Πᵢ holds on node data \vec{z}ᵢₙ,z_{loc},zₒᵤₜ, it also asserts existence of valid input proofs \vec{π}ᵢₙ attesting for the compliance of \vec{z}ᵢₙ.

Circuit Cᵢ - Proving node data is compliant with predicate Πᵢ
Public input: Node output data zₒᵤₜ and verification keys \vec{vk}ᵢₙ
Private input: Node input data \vec{z}ᵢₙ := (z_{in, 1}, . . . , z_{in, d}) with input proofs \vec{π}ᵢₙ := (π_{in, 1}, . . . , π_{in, d}), and
node local data z_{loc}
Description:
1. Check output data is of correct type. Thus, check zₒᵤₜ. type = i // The type of this predicate Πᵢ
2. Check node data is compliant. Thus, check Πᵢ(\vec{z}ᵢₙ, z_{loc}, zₒᵤₜ) = “accept”
3. Check all inputs have valid proofs. Thus, for j = 1, . . . , d check that Verify(vk_{in, j}, z_{in, j}, π_{in, j}) =
“accept”

Ensuring right input compliance. How can is be ensured that inputs are compliant with the right predicates? This is ensured as follows:
i. Each compliance predicate Πᵢ states which input types it accepts. Thus, it accepts inputs with i′:=z_{in,j}. type only if i′∈T_{in,i} for some subset T_{in,i}⊆{0, 1, . . . , n}.
ii. The first thing the template circuit Cᵢ checks is that the type of the output data zₒᵤₜ.type equals the type of the compliance predicate Πᵢ. Namely zₒᵤₜ.type=i. This means that an input z_{in,j} with a valid proof satisfies a circuit Cᵢ, such that z_{in,j}.type=i′ (because the proof is valid).

Putting both items together, it can be seen that inputs can only be compliant with respect predicates Πᵢ, such that i′∈T_{in,i}, where T_{in,i} is the set of allowed input types specified in the current node predicate Πᵢ.

The circuits in practice. For the sake of clarity, low-level details have been avoided and many optimizations made. Inputs and logic of the circuits is slightly different in practice.

Importantly, making the size of each circuit Cᵢ independent on the number of the predicates n requires checking a Merkle tree proof inside Cᵢ, and making Cᵢ well-defined requires moving the verification key to the private input, and passing a hash of it as public input.

### 8.2.2 Proving Satisfiability of the Circuit

SNARKs over elliptic curve cycles. For each circuit Cᵢ sketched above we consider two preprocessing SNARK schemes (G_{i,α},P_{i,α},V_{i,α}), (G_{i,β},P_{i,β},V_{i,β}) that are instantiated over an elliptic curve cycle. The first scheme (G_{i,α},P_{i,α},V_{i,α}) proves satisfiability of an [symbol] _{qβ}-arithmetic circuit and it is over an elliptic curve E/ [symbol] _{qα}, whereas the second scheme (G_{i,β},P_{i,β},V_{i,β}) proves satisfiability of an [symbol] _{qα}-arithmetic circuit and it is over an elliptic curve E/ [symbol] _{qβ}. Note the cycle pattern: the base field of the first curve coincides with the scalar field of the second curve, and the other way around, q_{β}:=#E/ [symbol] _{qα}, and q_{α}:=#E/ [symbol] _{qβ}.

Two-step proof generation. The first scheme (G_{i,α},P_{i,α},V_{i,α}) proves/verifies satisfiability of circuit Cᵢ, which is as an [symbol] _{qβ}-arithmetic circuit. To provide the inputs to Cᵢ we need the input proofs \vec{π}ᵢₙ:=(π_{in,1}, . . . , π_{in,d}) attesting to the compliance of the node's inputs \vec{z}ᵢₙ:=(z_{in,1}, . . . , z_{in,d}). Suppose z_{in,j} is compliant with predicate Π_{i′} where i′:=z_{in,j}.type. The first prover P_{i′,α} is used to generate a proof π_{α} that can be verified with V_{i′,α}. However, π_{α} cannot be directly used as input π_{in,j} to Cᵢ because the circuit for the verifier V_{i′,α} is an [symbol] _{qα}-arithmetic circuit (V_{i′,α} deals with points of the first curve E/ [symbol] _{qα}, so it is over the base field [symbol] _{qα}, and emulating [symbol] _{qα} arithmetic in an [symbol] _{qβ}-arithmetic circuit is expensive). To overcome this, a proof π_{β} is generated attesting to the validity of π_{α} (a proof of a proof). More precisely, the ‘translation’ circuit is constructed as:

$${\hat{C}}_{{i}^{′}} ( {z}_{in , j} , {π}_{{t}^{′} , α} ) := \{ \begin{matrix}1 & if {V}_{{i}^{′} , α} ( {z}_{in , j} , {π}_{{i}^{′} , α} ) = 1 \\ 0 & otherwise\end{matrix}$$

which is an [symbol] _{qα}-arithmetic circuit (because the first verifier V_{i′,α} is over the base field [symbol] _{qα}) and generate a proof π_{β} of satisfiability for Ĉᵢ, using the second prover P_{i′,β}. The input proofs π_{in,j} given to Cᵢ are the translation proofs π_{j,β}, and the verifier embedded as a subcircuit of Cᵢ (in step 3) is V_{i,β}. This is now well-defined since V_{i,β} can be expressed as an [symbol] _{qβ}-arithmetic circuit.

### 8.2.3 The PCD Scheme

Generator [symbol] . To generate the proving and verification keys: Let \vec{Π}:=(Π₁, . . . , Πₙ) be the compliance predicates. The PCD generator takes as input the compliance circuits (C₁, . . . , Cₙ) and their corresponding translation circuits (Ĉ₁, . . . , Ĉₙ). It generates proving/verification keys using the SNARK schemes: (pk_{i,α},vk_{i,α})←G_{α,i}(Cᵢ,λ), and (pk_{i,β},vk_{i,β})←G_{i,β}(Ĉᵢ,λ). It outputs the proving key

$${pk}_{pcd} := ( ( {pk}_{1 , α} , {vk}_{1 , α} , … , {pk}_{n , α} , {vk}_{n , α} ) , ( {pk}_{1 , β} , {vk}_{1 , β} , … , {pk}_{n , β} , {vk}_{n , β} ) ) ,$$

and verification key

$${vk}_{pcd} := ( {vk}_{1 , β} , … , {vk}_{n , β} ) .$$

Prover [symbol] . To prove node compliance with predicate Πᵢ: It receives as input the node data (inputs \vec{z}ᵢₙ local z_{loc} and output message zₒᵤₜ) the input proofs \vec{π}ᵢₙ and the corresponding verification keys \vec{vk}_{β} (to validate the input proofs). It generates a proof π_{α} of satisfiability of circuit Cᵢ using pk_{i,α} as proving key. Then it ‘translates’ the proof π_{α} into π_{β}. Thus, it proves satisfiability of Ĉᵢ using pk_{i,β} as proving key. It outputs πₒᵤₜ:==π_{β}.

Verifier [symbol] . To validate compliance of zₒᵤₜ with predicate Πᵢ: It receives as input the output data zₒᵤₜ and proof πₒᵤₜ. It computes b:=V_{i,β}(zₒᵤₜ,πₒᵤₜ) using the verification key vk_{i,β}. If b is accepting, it outputs “accept”. Else, outputs “reject”.

### 8.3 Elliptic Curves for Pairing-Based

8.3.1 What Curve Family to Choose—Stuck with MNT Curves

PCDs via SNARKs over pairing-friendly elliptic curves can be instantiated over a limited number of curves. The following impossibility results can be proven:
Barreto-Naehrig (BN) curves do not have cycles of elliptic curves.
There can only be cycles over prime-order curves.
MNT curves have only cycles of length 2 or 4. The embedding degrees must alternate between 4 and 6.

From the above, it can be concluded that the only practical cycle is the MNT4-MNT6 family.

### 8.3.2 Trading Security for Efficiency

It is possible to solve the discrete logarithm problem in any of the source groups if this problem is easy in the target group, which is a subgroup of the extension field [symbol] ₚ_{^{k}}. Here p is the prime order of the base field of the source curves, and k the embedding degree. The smaller p^{k} the easier to find discrete logarithm in the target group. On the contrary, the larger p or k the less efficient the computation of the pairing (it is preferable to have small p and large k).

Curves with small embedding degree K or prime p are desired for pairing-friendly applications, but not too small for security.

### 8.3.3 Security of MNT Curves

As of July 2022, to achieve a conservative 128-bit security level in pairing-friendly elliptic curves, the extension field must be of 5534 bits to resist latest cryptanalysis of discrete logs in [symbol] ₚ_{^{k}}. Other choices are possible as summarized in the table below. As mentioned above, MNT curves can only have embedding degrees 4 or 6. The security must be that of the curve with the smaller degree (4).

The following table provides three MNT cycles with their corresponding security level.

| | Base field | | Security | |
|---|---|---|---|---|
| | prime | Embedding | level | |
| Curve | (bits) | degree | (bits) | |
| MNT4-298 | 298 | 4 | 77 | (low) |
| MNT6-298 | 298 | 6 | 87 | |
| MNT4-753 | 753 | 4 | 113 | (medium) |
| MNT6-753 | 753 | 6 | 137 | |
| MNT4-992 | 992 | 4 | 126 | (high) |

| | | | |
|---|---|---|---|
| MNT6-992 | 992 | 6 | 156 |

### 9. FURTHER REMARKS

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However, it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

Some embodiments have been described in terms of the blockchain network implementing a proof-of-work consensus mechanism to secure the underlying blockchain. However proof-of-work is just one type of consensus mechanism and in general embodiments may use any type of suitable consensus mechanism such as, for example, proof-of-stake, delegated proof-of-stake, proof-of-capacity, or proof-of-elapsed time. As a particular example, proof-of-stake uses a randomized process to determine which blockchain node 104 is given the opportunity to produce the next block 151. The chosen node is often referred to as a validator. Blockchain nodes can lock up their tokens for a certain time in order to have the chance of becoming a validator. Generally, the node who locks the biggest stake for the longest period of time has the best chance of becoming the next validator.

It will be appreciated that the above embodiments have been described by way of example only. More generally there may be provided a method, apparatus or program in accordance with any one or more of the following Statements.

Statement 1. A computer-implemented method for generating a zero-knowledge proof for proving knowledge of a pre-image value, the method comprising: obtaining a series of pre-image blocks which, when combined, form the pre-image value; and executing a series of nodes, wherein each node of the series of nodes is configured to: receive a respective current state and a respective current iteration counter; evaluate an instance of a predefined compression function, based on the respective current state, to compute a respective next state; increment the respective current iteration counter to generate a respective next iteration counter; determine, based on a respective next pre-image block of the series of pre-image blocks, that the predefined compression function instance has been evaluated correctly; and output a proof, wherein the proof attests to the predefined compression function instance being evaluated correctly; wherein the proof generated by a final node of the series of nodes proves knowledge of the pre-image value.

Statement 2. The method of statement 1, wherein a first node of the series of nodes is further configured to: determine that the respective current state comprises an initialisation vector equal to a predefined initialisation vector; and determine that the respective current iteration counter has a first iteration count value.

Statement 3. The method of statement 1 or statement 2, wherein a final node of the series of nodes is further configured to: receive a padding pre-image portion; and determine if the padding pre-image portion is required to satisfy a padding condition; if it is determined that the padding pre-image portion is required, the final node is further configured to: evaluate a second instance of the predefined compression function, based on the respective next state computed by the final node based on the received respective current state, to compute a final state; increment the respective next iteration counter to generate a final iteration counter; and determine, based on the padding pre-image portion, that the second instance of the predefined compression function has been evaluated correctly; wherein the proof further attests to the second instance of the predefined compression function instance being evaluated correctly; if it is determined that the padding pre-image portion is not required: the respective next state computed by the final node is a final state and the respective next iteration counter computed by the final node is a final iteration counter.

Statement 4. The method of statement 3, wherein the final state comprises a hash of the pre-image value.

Statement 5. The method of statement 3 or statement 4, wherein the final node is further configured to: define a message; and determine that a last number of bits of the message is a binary expression of the bit length of the pre-image value, wherein the last number of bits is equal to the maximum bit length; wherein, if the bit length of the pre-image value is equal to the maximum bit length, the message is defined as the respective next state computed by the final node; and wherein, if the bit length of the pre-image value is less than the maximum bit length, the message is defined as the padding pre-image portion.

Statement 6. The method of any of statements 3 to 5, wherein the final node is further configured to: determine that the equation:

$$ℓ + 1 + k = m - {ℓ}_{max} + ( {i}_{o u t} - b ) \cdot m$$

is satisfied, wherein [symbol] is the bit length of the pre-image value, [symbol] ₘₐₓ is the maximum bit length, m is a length of each pre-image block, iₒᵤₜ is the final iteration counter, k is a positive integer equal to a difference between [symbol] ₘₐₓ and [symbol] , and b is a padding indicator, wherein b=1 if [symbol] = [symbol] ₘₐₓ and b=0 if [symbol] < [symbol] ₘₐₓ.

Statement 7. The method of statement 6, wherein the final node is further configured to: concatenate the respective next state computed by the final node and the padding pre-image portion; and check that a final k bits of the concatenation each has a value of zero and the preceding bit has a value of one.

Statement 8. The method of any preceding statement, wherein, for each of a second to final node of the series of nodes, the respective current state is received from a previous node in the series of nodes.

Statement 9. The method of any preceding statement, wherein each respective next state comprises a hash value.

Statement 10. The method of any preceding statement, wherein the proof is generated based on a proving key, wherein the proving key comprises the predefined compression function.

Statement 11. The method of statement 10, wherein the method further comprises providing the proof generated by the final node to a verifying entity, wherein the verifying entity has access to a verifying key associated with the proving key.

Statement 12. The method of any preceding statement, wherein the proof generated by the final node further proves presence of a predefined pattern in the pre-image, wherein the predefined pattern is described by a pattern bit array comprising a plurality of pattern bit array blocks, wherein a check bit array defines the bits of the pattern bit array defined by the predefined pattern and comprise a plurality of check bit array blocks, wherein each node of the series of nodes is further configured to: receive a respective next pattern bit array block and a respective next check bit array block; evaluate a next respective summary value, wherein the next respective state comprises the next respective summary value; determine that the next respective summary value has been evaluated correctly based on a respective current summary value, the pattern bit array, and the check bit array; and determine, based on the respective next pattern bit array block and the respective next check bit array block, that the respective next pre-image block hash matches a respective portion of the predefined pattern.

Statement 13. The method of statement 12, wherein the step of determining that the next respective summary value has been evaluated correctly comprises: computing a hash value based on the respective current summary value, the pattern bit array, and the check bit array; and comparing the computed hash to the evaluated next respective summary value; wherein the next respective summary value has been evaluated correctly if the computed hash is equal to the evaluated next respective summary value.

Statement 14. The method of any preceding statement, wherein the pre-image value is equal to a concatenation of the series of pre-image blocks.

Statement 15. The method of any preceding statement, wherein the current state and the next state are digest values corresponding to a respective one of the series of pre-image blocks.

Statement 16. A computer system comprising: at least one computing device comprising memory comprising one or more memory units and processing apparatus comprising one or more processing units, wherein the memory stores one or more portions of code arranged to run on the processing apparatus, wherein the code defines a series of nodes for generating a zero-knowledge proof for proving knowledge of a pre-image value, wherein each of the one or more portions of code corresponds to one or the nodes of the series of nodes, wherein each of the one or more portions of code, when executed, causes the processing apparatus to: obtain a respective next pre-image block of a series of pre-image blocks, wherein the series of pre-image blocks, when combined, form a pre-image value; obtain a respective current state and a respective current iteration counter; evaluate an instance of a predefined compression function, based on the respective current state, to compute a respective next state; increment the respective current iteration counter to generate a respective next iteration counter; determine, based on a respective next pre-image block of the series of pre-image blocks, that the predefined compression function instance has been evaluated correctly; and generate a proof, wherein the proof attests to the predefined compression function instance being evaluated correctly; wherein the proof generated by a final node of the series of nodes proves knowledge of the pre-image value.

Statement 17. The computer system of statement 16, wherein the portion of code corresponding to a first node of the series of nodes, when executed by the processing apparatus, further causes the processing apparatus to: determine that the respective current state comprises a component equal to a predefined initialisation vector; and determine that the respective current iteration counter has a first iteration count value.

Statement 18. The computer system of statement 16 or statement 17, wherein the portion of code corresponds to a final node of the series of nodes, when executed by the processing apparatus, further causes the processing apparatus to: receive a padding pre-image portion; and determine if the padding pre-image portion is required to satisfy a padding condition; if it is determined that the padding pre-image portion is required, the final node is further causes the processing apparatus to: evaluate a second instance of the predefined compression function, based on the respective next state computed by the final node based on the received respective current state, to compute a final state; increment the respective next iteration counter to generate a final iteration counter; and determine, based on the padding pre-image portion, that the second instance of the predefined compression function has been evaluated correctly; wherein the proof further attests to the second instance of the predefined compression function instance being evaluated correctly; if it is determined that the padding pre-image portion is not required: the respective next state computed by the final node is a final state and the respective next iteration counter computed by the final node is a final iteration counter.

Statement 19. The computer system of statement 18, wherein the portion of code corresponds to a final node of the series of nodes, when executed by the processing apparatus, further causes the processing apparatus to: define a message; and determine that a last number of bits of the message is a binary expression of the bit length of the pre-image value, wherein the last number of bits is equal to the maximum bit length; wherein, if the bit length of the pre-image value is equal to the maximum bit length, the message is defined as the respective next state computed by the final node; and wherein, if the bit length of the pre-image value is less than the maximum bit length, the message is defined as the padding pre-image portion.

Statement 20. The computer system of statement 18 or statement 19, wherein the portion of code corresponds to a final node of the series of nodes, when executed by the processing apparatus, further causes the processing apparatus to: determine that the equation:

$$ℓ + 1 + k = m - {ℓ}_{max} + ( {i}_{out} - b ) \cdot m$$

is satisfied, wherein [symbol] is the bit length of the pre-image value, [symbol] ₘₐₓ is the maximum bit length, m is a length of each pre-image block, iₒᵤₜ is the final iteration counter, k is a positive integer equal to a difference between [symbol] ₘₐₓ and [symbol] , and b is a padding indicator, wherein b=1 if [symbol] = [symbol] ₘₐₓ and b=0 if [symbol] < [symbol] ₘₐₓ.

Statement 21. The computer system of statement 20, wherein the portion of code corresponds to a final node of the series of nodes, when executed by the processing apparatus, further causes the processing apparatus to: concatenate the respective next state computed by the final node and the padding pre-image portion; and check that a final k bits of the concatenation each has a value of zero and the preceding bit has a value of one.

Statement 22. The computer system of any of statements 14 to 21, wherein the processing apparatus is configured to receive the respective current state and the respective current iteration counter from a second computing device executing a second of the one or more portions of code.

Statement 23. The computer system of any of statements 16 to 22, wherein the proof generated by the final node further proves presence of a predefined pattern in the pre-image, wherein the predefined pattern is described by a pattern bit array comprising a plurality of pattern bit array blocks, wherein a check bit array defines the bits of the pattern bit array defined by the predefined pattern and comprise a plurality of check bit array blocks, wherein each of the one or more portions of code, when executed, further causes the processing apparatus to: receive a respective next pattern bit array block and a respective next check bit array block; evaluate a next respective summary value, wherein the next respective state comprises the next respective summary value; determine that the next respective summary value has been evaluated correctly based on a respective current summary value, the pattern bit array, and the check bit array; and determine, based on the respective next pattern bit array block and the respective next check bit array block, that the respective next pre-image block hash matches a respective portion of the predefined pattern.

Statement 24. The computer system of statement 23, wherein the step of determining that the next respective summary value has been evaluated correctly comprises: computing a hash value based on the respective current summary value, the pattern bit array, and the check bit array; and comparing the computed hash to the evaluated next respective summary value; wherein the next respective summary value has been evaluated correctly if the computed hash is equal to the evaluated next respective summary value.

Statement 25. The computer system of any of statements 14 to 24, wherein the system further comprises a verifying entity, wherein the verifying entity comprises memory and processing apparatus, wherein the memory of the verifying entity stores code which, when executed by the processing apparatus of the verifying entity, causes the processing apparatus to: obtain a verifying key, wherein the verifying key is associated with a proving key and the predefined compression function; receive, from the processing apparatus executing the one or more node, the proof generated by the final node; and verify, based on the received proof and the verifying key, that the proof is valid.

Statement 26. The method or system of any preceding statement, wherein the pre-image value corresponds to a digest computed by applying a SHA2 hash function to the pre-image value.

1. A computer-implemented method for generating a zero-knowledge proof for proving knowledge of a pre-image value, the method comprising:
obtaining a series of pre-image blocks which, when combined, form the pre-image value; and
executing a series of nodes, wherein each node of the series of nodes is configured to:
receive a respective current state and a respective current iteration counter;
evaluate an instance of a predefined compression function, based on the respective current state, to compute a respective next state;
increment the respective current iteration counter to generate a respective next iteration counter;
determine, based on a respective next pre-image block of the series of pre-image blocks, that the predefined compression function instance has been evaluated correctly; and
output a proof, wherein the proof attests to the predefined compression function instance being evaluated correctly;
wherein the proof generated by a final node of the series of nodes proves knowledge of the pre-image value.

2. The method of claim 1, wherein a first node of the series of nodes is further configured to:
determine that the respective current state comprises an initialisation vector equal to a predefined initialisation vector; and
determine that the respective current iteration counter has a first iteration count value.

3. The method of claim 1, wherein a final node of the series of nodes is further configured to:
receive a padding pre-image portion; and
determine if the padding pre-image portion is required to satisfy a padding condition;
if it is determined that the padding pre-image portion is required, the final node is further configured to:
evaluate a second instance of the predefined compression function, based on the respective next state computed by the final node based on the received respective current state, to compute a final state;
increment the respective next iteration counter to generate a final iteration counter; and
determine, based on the padding pre-image portion, that the second instance of the predefined compression function has been evaluated correctly;
wherein the proof further attests to the second instance of the predefined compression function instance being evaluated correctly;
if it is determined that the padding pre-image portion is not required:
the respective next state computed by the final node is a final state and the respective next iteration counter computed by the final node is a final iteration counter.

4. The method of claim 3, wherein the final state comprises a hash of the pre-image value.

5. The method of claim 3, wherein the final node is further configured to:
define a message; and
determine that a last number of bits of the message is a binary expression of the bit length of the pre-image value, wherein the last number of bits is equal to the maximum bit length;
wherein, if the bit length of the pre-image value is equal to the maximum bit length, the message is defined as the respective next state computed by the final node; and
wherein, if the bit length of the pre-image value is less than the maximum bit length, the message is defined as the padding pre-image portion.

6. The method of claim 3, wherein the final node is further configured to:
determine that the equation:
$$ℓ + 1 + k = m - {ℓ}_{max} + ( {i}_{out} - b ) \cdot m$$
is satisfied, wherein [symbol] is the bit length of the pre-image value, [symbol] ₘₐₓ is the maximum bit length, m is a length of each pre-image block, iₒᵤₜ is the final iteration counter, k is a positive integer equal to a difference between [symbol] ₘₐₓ and [symbol] , and b is a padding indicator, wherein b=1 if [symbol] = [symbol] ₘₐₓ and b=0 if [symbol] < [symbol] ₘₐₓ.

7. The method of claim 6, wherein the final node is further configured to:
concatenate the respective next state computed by the final node and the padding pre-image portion; and
check that a final k bits of the concatenation each has a value of zero and the preceding bit has a value of one.

8. The method of claim 1, wherein, for each of a second to final node of the series of nodes, the respective current state is received from a previous node in the series of nodes.

9. The method of claim 1, wherein each respective next state comprises a hash value.

10. The method of claim 1, wherein the proof is generated based on a proving key, wherein the proving key comprises the predefined compression function.

11. The method of claim 10, wherein the method further comprises providing the proof generated by the final node to a verifying entity, wherein the verifying entity has access to a verifying key associated with the proving key.

12. The method of claim 1, wherein the proof generated by the final node further proves presence of a predefined pattern in the pre-image, wherein the predefined pattern is described by a pattern bit array comprising a plurality of pattern bit array blocks, wherein a check bit array defines the bits of the pattern bit array defined by the predefined pattern and comprise a plurality of check bit array blocks, wherein each node of the series of nodes is further configured to:
receive a respective next pattern bit array block and a respective next check bit array block;
evaluate a next respective summary value, wherein the next respective state comprises the next respective summary value;
determine that the next respective summary value has been evaluated correctly based on a respective current summary value, the pattern bit array, and the check bit array; and
determine, based on the respective next pattern bit array block and the respective next check bit array block, that the respective next pre-image block hash matches a respective portion of the predefined pattern.

13. The method of claim 12, wherein the step of determining that the next respective summary value has been evaluated correctly comprises:
computing a hash value based on the respective current summary value, the pattern bit array, and the check bit array; and
comparing the computed hash to the evaluated next respective summary value;
wherein the next respective summary value has been evaluated correctly if the computed hash is equal to the evaluated next respective summary value.

14-15. (canceled)

16. A computer system, comprising:
at least one computing device comprising memory comprising one or more memory units and a processing apparatus comprising one or more processing units, wherein the memory stores one or more portions of code arranged to run on the processing apparatus, wherein, when executed by the processing apparatus, the code causes the processing apparatus to define a series of nodes for generating a zero-knowledge proof for proving knowledge of a pre-image value, wherein each of the one or more portions of code corresponds to one or the nodes of the series of nodes, wherein each of the one or more portions of code, when executed, causes the processing apparatus to:
obtain a respective next pre-image block of a series of pre-image blocks, wherein the series of pre-image blocks, when combined, form a pre-image value;
obtain a respective current state and a respective current iteration counter;
evaluate an instance of a predefined compression function, based on the respective current state, to compute a respective next state;
increment the respective current iteration counter to generate a respective next iteration counter;
determine, based on a respective next pre-image block of the series of pre-image blocks, that the predefined compression function instance has been evaluated correctly; and
generate a proof, wherein the proof attests to the predefined compression function instance being evaluated correctly;
wherein the proof generated by a final node of the series of nodes proves knowledge of the pre-image value.

17. The computer system of claim 16, wherein the portion of code corresponding to a first node of the series of nodes, when executed by the processing apparatus, further causes the processing apparatus to:
determine that the respective current state comprises a component equal to a predefined initialisation vector; and
determine that the respective current iteration counter has a first iteration count value.

18. The computer system of claim 16, wherein the portion of code corresponds to a final node of the series of nodes, when executed by the processing apparatus, further causes the processing apparatus to:
receive a padding pre-image portion; and
determine if the padding pre-image portion is required to satisfy a padding condition;
if it is determined that the padding pre-image portion is required, the final node is further causes the processing apparatus to:
evaluate a second instance of the predefined compression function, based on the respective next state computed by the final node based on the received respective current state, to compute a final state;
increment the respective next iteration counter to generate a final iteration counter; and
determine, based on the padding pre-image portion, that the second instance of the predefined compression function has been evaluated correctly;
wherein the proof further attests to the second instance of the predefined compression function instance being evaluated correctly;
if it is determined that the padding pre-image portion is not required:
the respective next state computed by the final node is a final state and the respective next iteration counter computed by the final node is a final iteration counter.

19. (canceled)

20. The computer system of claim 18, wherein the portion of code corresponds to a final node of the series of nodes, when executed by the processing apparatus, further causes the processing apparatus to:
determine that the equation:
$$ℓ + 1 + k = m - {ℓ}_{max} + ( {i}_{out} - b ) \cdot m$$
is satisfied, wherein [symbol] is the bit length of the pre-image value, [symbol] ₘₐₓ is the maximum bit length, m is a length of each pre-image block, iₒᵤₜ is the final iteration counter, k is a positive integer equal to a difference between [symbol] ₘₐₓ and [symbol] , and b is a padding indicator, wherein b=1 if [symbol] = [symbol] ₘₐₓ and b=0 if [symbol] < [symbol] ₘₐₓ.

21. (canceled)

22. The computer system claim 16, wherein the processing apparatus is configured to receive the respective current state and the respective current iteration counter from a second computing device executing a second of the one or more portions of code.

23. The computer system of claim 16, wherein the proof generated by the final node further proves presence of a predefined pattern in the pre-image, wherein the predefined pattern is described by a pattern bit array comprising a plurality of pattern bit array blocks, wherein a check bit array defines the bits of the pattern bit array defined by the predefined pattern and comprise a plurality of check bit array blocks, wherein each of the one or more portions of code, when executed, further causes the processing apparatus to:
receive a respective next pattern bit array block and a respective next check bit array block;
evaluate a next respective summary value, wherein the next respective state comprises the next respective summary value;
determine that the next respective summary value has been evaluated correctly based on a respective current summary value, the pattern bit array, and the check bit array; and
determine, based on the respective next pattern bit array block and the respective next check bit array block, that the respective next pre-image block hash matches a respective portion of the predefined pattern.

24. The computer system of claim 23, wherein the step of determining that the next respective summary value has been evaluated correctly comprises:
computing a hash value based on the respective current summary value, the pattern bit array, and the check bit array; and
comparing the computed hash to the evaluated next respective summary value;
wherein the next respective summary value has been evaluated correctly if the computed hash is equal to the evaluated next respective summary value.

25-26. (canceled)
